(19) United States
(12) Patent Application Publication
(10) Pub. No.: US 2013/0105370 A1
(43) Pub. Date: May 2, 2013

(54) Construction de-watering high-volume, multi-separation system and method

(71) Applicant: Wayne W. Spani, Mission Viejo, CA (US)

(72) Inventor: Wayne W. Spani, Mission Viejo, CA (US)

(21) Appl. No.: 13/661,012

(22) Filed: Oct. 25, 2012

Related U.S. Application Data
(60) Provisional application No. 61/628,176, filed on Oct. 26, 2011.

(51) Int. Cl. B01D 36/00

(52) U.S. Cl. CPC B01D 36/00
USPC 210/85

(57) ABSTRACT

A construction de-watering high volume multi-separation system for use in removing a fluid medium from a construction site including a mechanical subsystem and a programmable computer control subsystem where the mechanical subsystem includes a high volume inlet for injecting a fluid medium, a chemical metering pump for injecting engineered chemicals into the fluid medium for separating a plurality of targeted compounds and controlling the pH level of the fluid medium, a multi-separation unit including a continuous loop conveyor for capturing sediment and floating contamination in the fluid medium, the programmable computer control subsystem arranged for continuously monitoring and comparing sensed parameters from the mechanical subsystem with pre-programmed input data, generating correction signals fed back to the mechanical subsystem for maintaining the sensed parameters within limitations, and for continuously adjusting and reporting in real time to a regulatory authority the operation of the mechanical subsystem.

This patent application claims the priority date of and incorporates by reference the previously filed provisional patent application under 35 U.S.C. Section 111(b) entitled The High Volume Multi-Separation System (HVMSS) filed on Oct. 26, 2011 by Wayne William Spani and assigned the Provisional Application No. 61/628,176. This patent application further incorporates by reference via patent license agreement, U.S. Pat. No. 5,812,394 issued to Lewis et al. on Sep. 22, 1998, and U.S. patent application having Ser. No. 13/610,800 filed on Sep. 11, 2012.

### BACKGROUND OF THE INVENTION

1. Technical Field

The present invention relates to water quality systems. More specifically, the present invention relates to methods and apparatus for a construction de-watering high volume, multi-separation system and method utilized to extract and remove debris and sediment from a fluid medium during de-watering projects at construction sites prior to surface water discharge, and more particularly to an active treatment process controlled by a programmable computer control subsystem that receives input signals from and transmits correction control signals to the construction de-watering high volume, multi-separation system via a control feedback loop for continuously controlling and verifying the operation of the construction de-watering system as per local, state and federal regulatory authority.

2. Background Art

During large construction projects such as driving a piling, that is, a heavy beam of timber, concrete, or steel, into the earth as a below-grade foundation or support for a structure during, for example, the construction of high rise buildings, it is not uncommon to come in contact with underground water sources. The introduction of an underground water source will likely flood and interrupt the construction process. Consequently, the fluid medium associated with the underground water source must be removed so that the construction pilings can be set and the supporting concrete can cure. Typically, the progress on the construction project must be stopped until the fluid medium is removed.

The process of removing the fluid medium from an underground water source which has flooded, for example, a construction project is referred to as “de-watering”. Thus, de-watering is the removal of a fluid medium, such as dirty water, from a construction site, pit, pond, river, or any water source. Typically, the de-watering process is accomplished by withdrawing the fluid medium from the construction site by utilizing large industrial pumps such as, for example, submersible pumps. As the fluid medium is withdrawn from the construction site, pit, pond, river, or other water source, it is pumped to a holding tank which serves as a large settling basin. In the prior art, the settling basin typically was a large mobile trailer on wheels which received approximately two-hundred gallons/minute of the fluid medium or dirty water pumped from the flooded construction site. It was also desirable to remove debris, sediment or mud from the fluid medium during the de-watering process. In the prior art, a “natural settlement process” was utilized in the mobile settling basin to enable the sediment and dirt to settle to the bottom of the mobile settling basin. The sediment includes a plurality of components including debris, trash, gravel, but particularly sand, silt, dirt, and clay, and in some cases metals, oils, greases and other compounds.

The sediment in the fluid medium was permitted to settle in the mobile settling basins of the prior art where the debris, trash, metals, oils and greases and other lighter components would float upward for removal while the sand, silt, dirt and clay and other heavier components would drift downward to the bottom of the mobile settling basin. This procedure would take three days (e.g., 72 hours) or more to complete. Then the fluid medium, typically dirty water, would be pumped out of the mobile settling basin and returned to the pit, pond, river, or other water source where it would not interfere with the activity at the construction site. Once the water was pumped out of the mobile settling basin, the sediment appearing as “mud” located on the floor of the settling basin, was removed manually by people with shovels. This process is very time consuming, laborious and inefficient. The processed fluid medium pumped out of the mobile settling basin must meet certain water quality standards before the fluid medium pumped into the mobile settling basin may be discharged back to the pit, pond, river, or other water source and particularly to a city storm water drain system. The discharge water quality standards are defined by, for example, the construction license permit issued to the business by the local Regional Water Quality Control Board for a specific purpose. The operations of the holders and users of these issued permits are periodic inspected to ensure compliance.

Additional techniques have been utilized in the prior art to remove the sediment, chemicals and pollutants present in the fluid medium associated with the underground water sources. During the process of pumping the fluid medium into and/or out of the mobile settling tanks, media filter systems comprised of sand or anthracite, carbon, pulverized walnut shells or the like to trap or absorb chemicals and pollutants as required by the relevant license permits. Media filters are manufactured by specific companies and are installed by environment companies. Unfortunately, current media filters in use are not efficient and become clogged with sediment, chemicals and debris and thus require pressure provided by the submersible pumps to drive the fluid medium through the media filter. Notwithstanding, the media filters become hopelessly clogged and essentially non-functional.

The media filtration system is known in the industry as a “passive filtration system”. In order to keep this system functioning properly, the passive media filter must be changed out regularly. This is typically accomplished by shoveling, for example, sand out of a pressure container associated with the media filter and then replacing fresh media back into the pressure container of the media filter. The holders of the license or permit issued by the Regional Water Quality Control Board are saddled with the financial burden to maintain the media filter in working order. Unfortunately, the passive filtration system is not efficient and water samples fail the discharge tests notwithstanding the presence or absence of a properly working media filter. Inspectors from the Regional Water Quality Control Board are assigned to inspect and test the fluid medium flowing downstream of the media filters by extracting a water sample. Much fraud exists in that {a} media filters are removed by owner personnel to avoid the clogging problem, {b} the Water Quality Control Board is under-staffed, or {c} the inspection personnel fail to collect the downstream water samples since it is an undesirable task.

Prior art patents will now be mentioned that appear to be somewhat relevant to the Construction De-Watering High Volume, Multi-Separation System And Method of the present invention.

In U.S. Pat. No. 7,083,721 (McClure et al., Aug. 1, 2006) and U.S. Patent Publication No. US 2004/0226869 (McClure et al., Nov. 18, 2004), a hydraulic-permeation type environmental water-runoff filtration system applicable to street curb-inlet type drainage chambers which cooperatively interconnect with street and parking-lot drains, utilizes a pollution trap employing a basic built-in-place containment housing which can be readily adapted to the studied needs without incurring alteration of existing sewer-storm drains. The containment housing enables selectively structuring multi-stages of filtration, which progressions address a variety of ecosystem-contaminants, ranging from basic street refuge and floatable objects, to course sediment, finer silt, and comparatively minute albeit environmentally-hazardous petrochemicals, heavy-metals, phosphates, and nitrates. Each of these contaminants are readily retrieved from the confines of the filtration system via periodic maintenance.

In U.S. Patent Publication No. US 2005/0279710 (Clemons, SR., Dec. 22, 2005), an apparatus and method for treating wastewater with a flocculant is disclosed. The waste water is mixed with a flocculant so that the contaminants and pollutants within the water are absorbed by the flocculant. The mixture is then transported from a mixing tank to a gravity bed filter having a filter media conveying means. The filter media is conveyed to a second end as the mixture is transported to the first end. Clean water seeps from the mixture and is collected in a basin.

In U.S. Pat. No. 6,638,424 (Stever et al., Oct. 28, 2003); U.S. Patent Publication No. US 2004/0069715 (Stever et al., Apr. 15, 2004); U.S. Pat. No. 7,001,527 (Stever et al., Feb. 21, 2006); and U.S. Pat. No. 7,638,065 (Stever et al., Dec. 29, 2009); a liquid purification and separation apparatus for separation of pollutants in storm water runoff is disclosed. This apparatus utilizes gravitation separation and tortuosity, resulting from a plurality of baffles both perpendicular to and oblique to the primary water flow direction, to trap substances less-dense and more-dense than water. The apparatus features improved resistance to pollutant re-mobilization through treatment of water volume rather than flow rates, using vertically stacked water columns of varying depths to settle small particles. An overflow structure diverts excessive liquid without interfering with purification and separation, and can be placed integrally within or external to the apparatus receptacle.

In U.S. Pat. No. 6,797,161 (Use et al., Sep. 28, 2004), a multi-stage water pollution trap for separating pollutants from a liquid is disclosed and comprises a chamber having an inlet and an outlet, a screen disposed in the chamber between the inlet and the outlet, one or more baffles disposed in the chamber between the inlet and the outlet, a collection reservoir with a skimming edge disposed in the chamber, and a pivotal filter disposed in the chamber.

In U.S. Patent Publication No. US 2003/0071737 (Nawathe, Apr. 17, 2003), an automated storm water monitoring system and method is disclosed wherein storm water running at a construction site is monitored from an off-site location. When rainfall of a selected level is detected on site, a specimen of runoff is collected and an off-site station is signaled that the event has occurred. The off-site station then may dispatch a courier to the construction site to collect the specimen for analysis.

In U.S. Pat. No. 7,033,496 (Thacker et al., Apr. 25, 2006), a water clarification system is disclosed which includes a casing surrounding a horizontal axis to define a cavity having a top, bottom, and axially front and rear ends. The casing is configured to conduct a mixture of a liquid and debris through the cavity from the front end to the rear end. Front and rear walls cap the casing at the front and rear ends and a horizontal outlet tube extends through the rear wall and defines a horizontal outlet channel with a bottom. A transversely-extending weir extends upward from the bottom of the cavity. The weir has a horizontal top edge located above the channel bottom and spaced below the top of the cavity, and further has fluid flow apertures below the channel bottom.

In U.S. Pat. No. 6,277,274 (Coffman, Aug. 21, 2001), a method and apparatus for treating storm water runoff is disclosed. A water treatment system, method and apparatus is utilized for removing sediment, chemical pollutants and debris from contaminated storm water runoff using physical, chemical and biological processes by passing runoff water preferably through a two-stage filtering and treatment system. A first stage chamber filter system comprises a water storage area, a mulch layer, a soil mixture of aggregate, organic material, soil, and live woody and/or herbaceous plants. The second stage treatment system is a water-filled lower chamber with baffles to increase the flow path of treated runoff through the chamber.

In U.S. Pat. No. 7,311,818 (Gurfinkel, Dec. 25, 2007), a water separation unit is disclosed having an inner housing for storm water collection, separation of oils and debris from the storm water, and discharge of clean water. The inner housing is suspended inside an outer housing. The inner housing has a translatable floor with a plurality of hollow tubes extending upward from the floor and downward through the floor for passage of clean water from the inner housing and out the water separation unit. A plurality of conduits collect the clean water as it escapes from the inner housing and carries the clean water to a discharge tube and out the water separation unit.

In U.S. Pat. No. 6,346,197 (Stephenson et al., Feb. 12, 2002), a water and wastewater treatment system and process for contaminant removal is disclosed. The system and process for removing contaminants from water and waste water, where the water or waste water is transformed into purified water that can be discharged to the environment. Wastewater is transported through several stations for purification, including an electro-chemical cell having parallel conductive plates for the electro-coagulation of the wastewater, a floatation tank downstream of the cell for flotation separation of the solids from the waste water and a conduit connecting the cell to the flotation tank to direct wastewater from the cell to the tank. A reagent dispenser communicates with the conduit to dispense a coagulation-inducing reagent into the wastewater in the conduit. A mixer for mixing the wastewater in the conduit with the reagent to cause coagulation of the solids and with gas in the wastewater to cause at least some of the solids to be directed upwardly to the surface.

In U.S. Patent Publication No. US 2009/0039001 (Monteith, Feb. 12, 2009) and U.S. Patent Publication No. US 2007/0119764 (Monteith, May 31, 2007), an enhanced separation tank with pH control is disclosed. A water-handling installation comprises a tank interceptor for receiving liquid and in which oil or separated solids are separated from the liquid prior to discharge. The water-handling installation further comprises a pH adjustment module in fluid communication with the tank interceptor. The pH adjustment module receives a portion of liquid contained in the tank interceptor and adjusts the pH thereof prior to returning the diverted portion back to the tank interceptor.

Thus, there is a need in the art for a construction de-watering high volume, multi-separation system and method having {a} a mechanical subsystem for separating and removing sediment, targeted compounds, and floating contamination from a fluid medium by utilizing a multi-separation unit having a continuous loop conveyor for capturing and disposing of the sediment, compounds and contamination, and {b} a programmable computer control subsystem (PCCS) arranged for continuous real time monitoring and continuous comparing of a plurality of sensed parameters from the mechanical subsystem with a plurality of pre-programmed input data for generating a plurality of correction signals fed back to the mechanical subsystem for maintaining the sensed parameters of the fluid medium within limitations set by and reported to a regulatory authority in real time.

### DISCLOSURE OF THE INVENTION

Briefly, and in general terms, the present invention provides a new and improved construction de-watering high volume, multi-separation system and method for use in removing a fluid medium from a construction site and improving it's condition prior to discharge. The present invention includes a mechanical subsystem and a programmable computer control subsystem (PCCS) utilized to remove sediment, targeted compounds, and floating contamination from the fluid medium extracted from the construction site in accordance with the specifications of the Regional Water Quality Control Board. Further, the present invention is an active fluid treatment process within an innovative single unit design that includes the mechanical subsystem and programmable computer control subsystem (PCCS) where the mechanical subsystem is constantly monitored and controlled by the programmable computer control subsystem (PCCS). The programmable computer control subsystem (PCCS) receives a continuous stream of sensed parameter input signals or input data from the mechanical subsystem and then transmits revised and updated correction signals back to the mechanical subsystem via a control feedback loop. This design enables continuous adjusting and reporting in real time to the Regional Water Quality Control Board of the condition of the captured fluid medium and the operation of the construction de-watering high volume, multi-separation system.

In the construction de-watering high volume, multi-separation system and method, the programmable computer control subsystem (PCCS) controls and continuously monitors the sensed parameters and operation of the mechanical subsystem. The function of the mechanical subsystem is to capture the fluid medium (such as dirty water located at a construction site), separate sediment, a plurality of targeted compounds, and floating contamination from the fluid medium, mechanically dispose of the sediment, targeted compounds, and floating contamination, and then discharge the processed fluid medium back to surface water discharge such as streams, lakes and rivers in accordance with the rules of the Regional Water Quality Control Board. Each of the components of the mechanical subsystem communicates electronically with the programmable computer control subsystem (PCCS) for enabling continuous monitoring and operational control of the mechanical subsystem by the programmable computer control subsystem (PCCS). This unique design enables convenient, remote on-line monitoring and fluid sample evaluation by the Regional Water Quality Control Board of the fluid medium at, for example, the discharge stage of the construction de-watering high volume, multi-separation system.

The mechanical subsystem includes a high volume inlet which receives the captured fluid medium (such as dirty water) located at a construction site and that is pumped from commercial and industrial sites and is collected and routed to a large debris filter stage. The objective of the present invention is the removal of debris, trash, large objects, gravel, sediments {sand, silt, clay, dirt}, metals, oils, greases and other chemical compounds from the fluid medium 102 located at and removed from construction sites to meet the discharge requirements of the Regional Water Quality Control Board. The filtered fluid medium including the solution of sediment, targeted compounds, and fine floating contamination is pumped through the mechanical subsystem by a plurality of transfer pumps to a first bank of parameter sensors. The first bank of parameter sensors collect real time measurements of the sensed parameters including temperature, pH, resistivity and conductivity, flow rate/totalizer, turbidity, and residual chemical concentrations which are reported to the programmable computer control subsystem (PCCS). The sensed parameters are measured at several locations throughout the construction de-watering high volume, multi-separation system and are utilized to compare to a plurality of pre-programmed data in the programmable computer control subsystem (PCCS) for generating a plurality of correction signals.

The fluid medium is then directed to a V-shaped multi-separation unit having four separate chambers and a plurality of baffle partitions for creating a tortuous pathway for the fluid medium. The first chamber of the multi-separation unit is injected with a mix of engineered chemicals for separating out the targeted compounds and for controlling the pH level of the fluid medium. This section of the mechanical subsystem includes (1) a flocculation tank, (2) chemical metering pumps, (3) and a pH adjustment chemical tank. The chemical metering pumps function to measure and inject the engineered chemicals into the fluid medium within the multi-separation unit under the control of the programmable computer control subsystem (PCCS). Also included is (4) a pair of flocculant media mixers (only one shown) with dual propellers to ensure that the engineered chemicals injected into the multi-separation unit are thoroughly mixed with the targeted compounds present in the fluid medium.

The fluid medium along with the targeted compounds and engineered chemicals are forced through the first chamber of the multi-separation unit. Also, (1) a blower/air pump and (2) a fine air bubblier are associated with the multi-separation unit. The fine air bubblier is utilized to create fine bubbles for the flocculant of the engineered chemicals to attach to, that is, the fine air bubblier is included for creating fine bubbles for mixing with the fluid medium, targeted compounds, and engineered chemicals. The blower/air pump functions to forcibly distribute air throughout the fluid medium, that is, the blower/air pump serves to mix the bubbles into the engineered chemicals (flocculants), targeted compounds within the dirty water, and sediment. The combination of the fluid medium, targeted compounds and engineered chemicals create a floating agglomeration in the multi-separation unit. The fine bubbles and forced air within the fluid medium assist in the formation and rise of the floating agglomeration in the fluid medium. The floating agglomeration or contamination rises to the top of the fluid medium and is mechanically removed typically by being routed into a plurality of float drains that are directed to a filter press.

The processed fluid medium is then passed through the remaining three chambers of the multi-separation unit. Each of the baffle partitions separating the four chambers includes a pattern of penetrations therein and extends downward so that the fluid medium can pass through the baffle penetrations and underneath the baffle partitions. Further, the bottom of the V-shaped multi-separation unit includes a continuous trough running the entire length thereof. A dual purpose sludge/float continuous loop conveyor cooperates with the trough and tracks along the vertical sidewalls, and over the top of the multi-separation unit. The construction of the continuous loop conveyor includes a pair of raceway channels formed in the trough through which a plurality of rolling conveyor buckets are pulled by a conveyor drive unit. The design of the multi-separation unit creates a slow tortuous path for the fluid medium to pass through which promotes (1) the slow decent of the sediment (i.e., sludge) to the bottom of the trough, and (2) the rise of the floating agglomeration or contamination to the top of the multi-separation unit. During the operation of the continuous loop conveyor, the rolling conveyor buckets (a) skim the bottom of the trough to collect the sediment (i.e., sludge having the consistency of mud) which is dumped into a chute at the top of the travel of the continuous loop conveyor, and (b) collect the floating agglomeration or contamination along the top of the continuous loop conveyor which is directed down float drains. Both the sediment (i.e., sludge) and the floating agglomeration are directed to the filter press for processing.

The processed fluid medium is then passed through a second bank and a third bank of parameter sensors for collecting real time measurements of the sensed parameters including temperature, pH, resistivity and conductivity, flow rate/totalizer, turbidity, and residual chemical concentrations which are reported to the programmable computer control subsystem (PCCS). If the quality of the fluid medium at the output of the second bank of parameter sensors fails to satisfy the discharge requirements of the Regional Water Quality Control Board, then the fluid medium may, if desired, be passed through the Programmable Fluid Treatment System And Method described in U.S. patent application Ser. No. 13/610,800 filed on Sep. 11, 2012 and assigned to a common party. Otherwise, the processed fluid medium may be transmitted directly to the third bank of parameter sensors via a final filter stage comprised of parallel transfer pumps and a bank of sock filters, and then on to an effluent discharge diffuser if the water quality is adequate for discharge. Otherwise, the once-processed fluid medium is re-routed to the multi-separation unit for re-processing.

The programmable computer control subsystem (PCCS) is employed for controlling and continuously monitoring each stage of the mechanical subsystem for ensuring proper operation thereof. Each major component of the mechanical subsystem is in electronic communication with the programmable computer control subsystem (PCCS). In this manner, the condition of the processed fluid medium will satisfy the regulations of the Regional Water Quality Control Board and the processed fluid medium will be discharged to surface water such as streams, lakes and rivers. The programmable computer control subsystem (PCCS) is housed within a National Electrical Manufacturers Association (NEMA) rated control panel enclosure which contains the main components including a plurality of digital/analog, input/output modules commonly referred to as an input/output board rack. Each of the sensor devices such as the multiple banks of parameter sensors located in the mechanical subsystem periodically sense, for example, the flow rate, temperature, pH, resistivity, conductivity, turbidity, and other parameters of the fluid medium. These sensed parameters are transmitted to and are identified by the input/output board rack located in the programmable computer control subsystem (PCCS) and are then forwarded to a field control unit (FCU) which is a local microprocessor unit.

The field control unit (FCU) continuously monitors the plurality of sensed parameters and is utilized for control logic execution and direct scanning of the sensed parameters (e.g., input/output data of the mechanical subsystem) from the input/output board rack into a computer located at an operator workstation. The operator workstation is utilized as an operator interface with the programmable computer control subsystem (PCCS). Among other functions, the computer continuously interprets and compares the sensed parameters with a plurality of pre-programmed input data stored within the computer for generating a plurality of correction signals. These correction signals are transmitted back to the field control unit (FCU) via a feedback loop and subsequently transmitted to the proper locations in the input/output board rack and the mechanical subsystem. These correction signals facilitate adjustments and control modifications to the mechanical subsystem for maintaining the sensed parameters of the fluid medium within the specified limitations set by the Regional Water Quality Control Board. Because of the continuous monitoring of the sensed parameters by the field control unit (FCU) and the continuous interpreting and comparing of the sensed parameters with the pre-programmed input data, the required adjustments and control modifications to the mechanical subsystem can be verified as having actually been made.

As a result, the present invention facilitates the continuous adjusting and correcting of the sensed parameters and reporting on-line and in real time to the regulatory authority. This continuous reporting includes the current operation of the mechanical subsystem including the mix of the engineered chemicals and the condition of the fluid medium. This important feature is extremely significant in that the concentration of the targeted compounds during a construction flooding event can be dynamic, that is, constantly changing. Thus the operation of the construction de-watering high volume, multi-separation system can be modified to address this dynamic situation. Under these conditions, the sensed parameters of temperature, pH, resistivity, conductivity, turbidity, flow rate, temperature, and residual chemical concentrations can be constantly monitored as well as flocculant chemical metering levels, pump speeds, fluid medium flow rates and the like. Thus, the rigid standards set by the Regional Water Quality Control Board can be satisfied prior to the discharge of the processed fluid medium into the local surface water sources such as streams, lakes and rivers.

Further features of the programmable computer control subsystem include an engineering work station (EWS). The engineering work station (EWS) is utilized by technical personnel to program logic code into and download that programmed logic code from a separate computer at an engineering work station (EWS) onto the computer located at the operator's work station (OWS) for changing parameters when changing-out field components or hardware. Only the programmer/engineer at the engineering work station (EWS) has access to the computer located at the engineering work station (EWS) which may be a desktop or laptop type. The computer located at the engineering work station (EWS) is typically a remote station and is used solely to write the programming logic and select the system configuration for the programmable fluid treatment system. Access from off-site locations (which can be any location external to the programmable fluid treatment system) is available to communicate with the computer at the operator's work station (OWS) for obtaining the most current sensed parameter readings available. Off-site locations, including the engineering work station (EWS), can communicate with the programmable fluid treatment system by any of several methods including, for example, radio frequency, modem, satellite, telephone lines, ethernet or internet, or the like. The construction de-watering high volume, multi-separation system includes an antenna to facilitate this communication.

The present invention is generally directed to a construction de-watering high volume, multi-separation system for use in removing a fluid medium from a construction site and having a mechanical subsystem and a programmable computer control subsystem (PCCS) where the mechanical subsystem includes a high volume inlet for injecting a fluid medium, a chemical metering pump for injecting engineered chemicals into the fluid medium for separating a plurality of targeted compounds and controlling the pH level of the fluid medium, a multi-separation unit including a continuous loop conveyor for capturing sediment deposited on the bottom of and contamination floating on the top of the fluid medium, the programmable computer control subsystem arranged for continuously monitoring and comparing a plurality of sensed parameters from the mechanical subsystem with pre-programmed input data, and for generating correction signals fed back to the mechanical subsystem for maintaining the sensed parameters within limitations, and for continuously adjusting and reporting in real time to a regulatory authority the operation of the mechanical subsystem.

These and other objects and advantages of the present invention will become apparent from the following more detailed description, taken in conjunction with the accompanying drawings which illustrate the invention, by way of example.

### BRIEF DESCRIPTION OF THE DRAWINGS

FIG. 1 is a block diagram of a Construction De-Watering High Volume Multi-Separation System And Method of the present invention showing a mechanical subsystem and a programmable computer control subsystem (PCCS) including an antenna for enabling communication therewith.

FIG. 2 is another block diagram of the Construction De-Watering High Volume Multi-Separation System And Method of FIG. 1 showing the mechanical subsystem and a more detailed view of the programmable computer control subsystem (PCCS) including a touch screen control.

FIGS. 3A-3B is a schematic diagram of the Construction De-Watering High Volume Multi-Separation System And Method of FIG. 1 showing a detailed view of the mechanical subsystem including influent inlet, large debris removal, engineered chemical injection, and the separation of sedimentation and floating contamination from a fluid medium via a continuous loop conveyor, and a block representing the programmable computer control subsystem (PCCS) shown in FIG. 2.

FIG. 4A is a top plan view of the multi-separation unit of the Construction De-Watering High Volume Multi-Separation System of FIGS. 3A-3B showing a trough associated with the dual purpose sludge/float continuous loop conveyor of the present invention.

FIG. 4B is a side elevation view of the multi-separation unit of the Construction De-Watering High Volume Multi-Separation System of FIGS. 3A-3B showing the dual purpose sludge/float continuous loop conveyor, a conveyor drive unit, a plurality of float drains, and an effluent outflow chamber of the present invention.

FIG. 4C is a perspective detail view of a conveyor bucket assembly associated with the continuous loop conveyor of the Construction De-Watering High Volume Multi-Separation System of FIG. 3B and FIG. 4B showing a conveyor bucket and a plurality of spreader bars for cooperating with the conveyor drive unit.

FIG. 4D is another perspective detail view of the conveyor bucket assembly associated with the continuous loop conveyor of the Construction De-Watering High Volume Multi-Separation System of FIG. 3B and FIG. 4B showing a plurality of rollers of the conveyor bucket positioned in a raceway channel mounted with the trough.

FIG. 4E is a cross-sectional view of the multi-separation unit of the Construction De-Watering High Volume, Multi-Separation System of FIG. 3B taken along the cross-sectional line A-A of FIG. 4A showing only the trough and associated float drains for the discharge of floating contamination.

FIGS. 5A-5C are three cross-sectional views of the multi-separation unit of the Construction De-Watering High Volume Multi-Separation System of FIG. 3B taken along the cross-sectional lines A-A, B-B, and C-C of FIG. 4A showing three separate baffle partitions having different patterns of penetrations for the passage of the fluid medium.

FIG. 6A is an end view of the influent inlet side of the multi-separation unit of the Construction De-Watering High Volume, Multi-Separation System of FIGS. 3A-3B.

FIG. 6B is an end view of the effluent outflow side of the multi-separation unit of the Construction De-Watering High Volume, Multi-Separation System of FIGS. 3A-3B.

FIG. 7 is a perspective view of a field control unit (FCU) combined with digital/analog-input/output modules which serve to enable communication between the mechanical subsystem and a computer in the programmable computer control subsystem (PCCS) of FIG. 2 for receiving and evaluating measured parameters from and returning correction signals to the mechanical subsystem.

FIG. 8 is an illustration of a communications link showing possible communication paths between the programmable computer control subsystem (PCCS) of the Construction De-Watering High Volume Multi-Separation System And Method of FIG. 2 and various known communication apparatuses.

FIGS. 9A-9C is a detailed flow diagram representing the operation of the Construction De-Watering High Volume Multi-Separation System And Method of FIG. 1 beginning with ground fluid medium located at a construction site and ending with the discharge of the processed fluid medium through an effluent discharge diffuser to surface water.

### DETAILED DESCRIPTION OF THE INVENTION

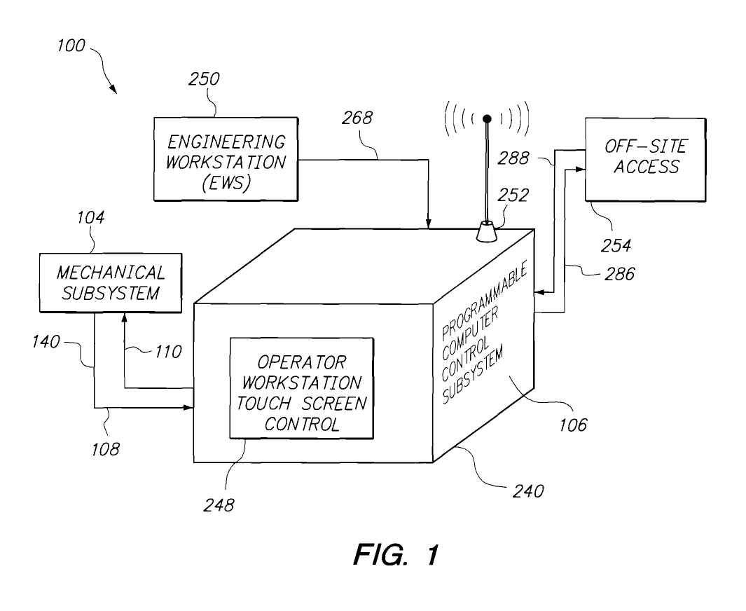

The present invention relates to a construction de-watering high volume, multi-separation system and method 100 as shown in FIGS. 1-9C (hereinafter referred to as the construction de-watering system 100). The construction de-watering system 100 is utilized for removing a fluid medium 102 from a construction site (not shown) and improving it's condition prior to discharge. In particular, the construction de-watering system 100 includes a mechanical subsystem 104 and a programmable computer control subsystem (PCCS) 106 utilized to remove sediment 112, targeted compounds 114, and floating contamination 116 from the fluid medium 102 extracted from the construction site in accordance with the specifications and regulations of the Regional Water Quality Control Board to ensure that the fluid medium 102 meets the required conditions prior to discharge.

Further, the construction de-watering high volume, multi-separation system 100 is an “active fluid treatment system” that includes the mechanical subsystem 104 and the programmable computer control subsystem (PCCS) 106 where the mechanical subsystem 104 is constantly monitored and controlled by the programmable computer control subsystem (PCCS) 106. The programmable computer control subsystem (PCCS) 106 receives a continuous stream of sensed parameters 108 as input signals or input data from the mechanical subsystem 104 and then transmits revised and updated correction signals 110 back to the mechanical subsystem 104 via a control feedback loop. This design enables the continuous adjusting and reporting in real time to the Regional Water Quality Control Board of the condition of the captured fluid medium 102 and the operation of the construction de-watering high volume, multi-separation system 100.

In the construction de-watering high volume, multi-separation system and method 100, the programmable computer control subsystem (PCCS) 106 controls and continuously monitors the plurality of sensed parameters 108 and operation of the mechanical subsystem 104. The function of the mechanical subsystem 104 is to capture the fluid medium 102 (such as dirty water located at a construction site), separate sediment 112, a plurality of targeted compounds 114, and floating contamination 116 from the fluid medium 102, mechanically dispose of the sediment 112, targeted compounds 114, and floating contamination 116, and then discharge the processed fluid medium 102 back to surface water discharge such as streams, lakes and rivers in accordance with the regulations of the Regional Water Quality Control Board. Each of the components of the mechanical subsystem 104 communicates electronically with the programmable computer control subsystem (PCCS) 106 for enabling continuous monitoring and operational control of the mechanical subsystem 104 by the programmable computer control subsystem (PCCS) 106. This unique design enables convenient, remote on-line monitoring and fluid sample evaluation by the Regional Water Quality Control Board of the fluid medium 102 at, for example, the discharge stage of the construction de-watering high volume, multi-separation system 100.

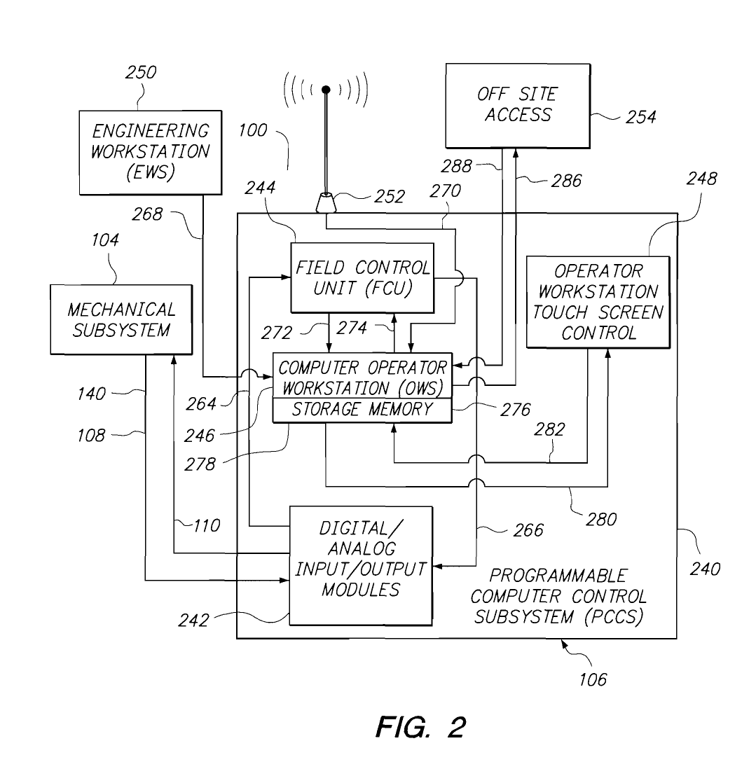

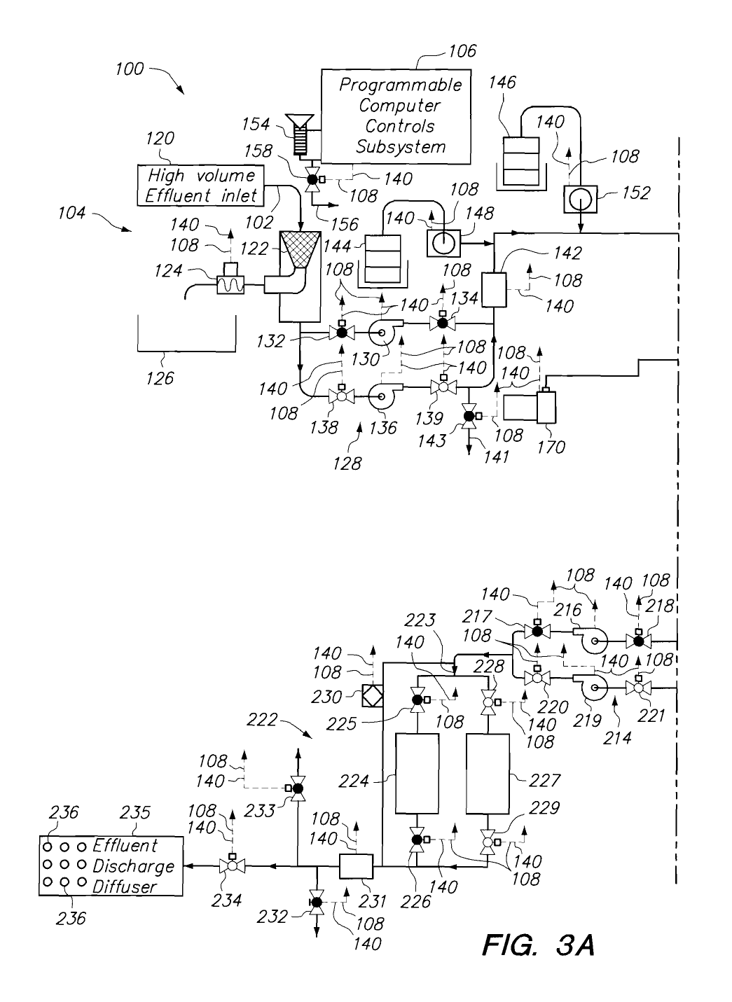

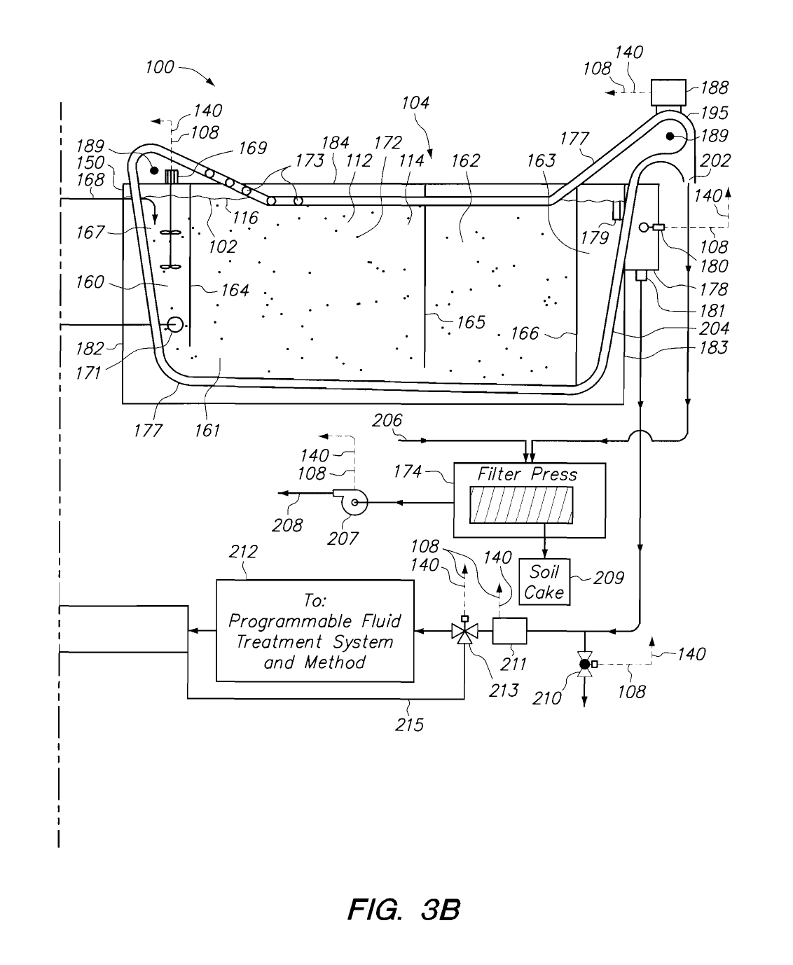

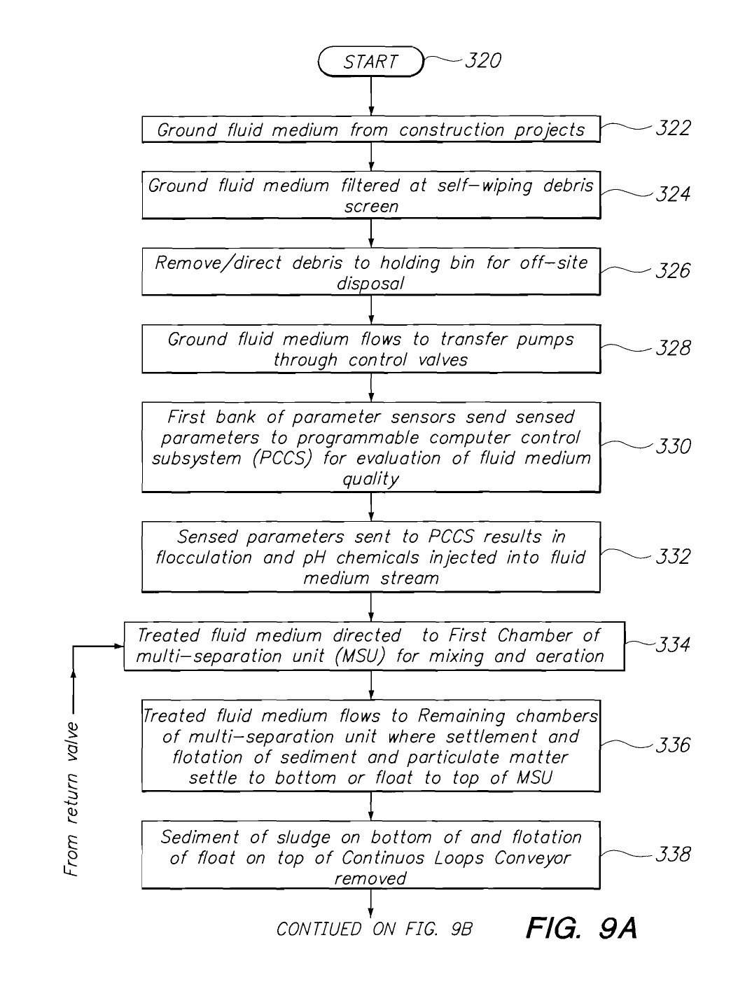

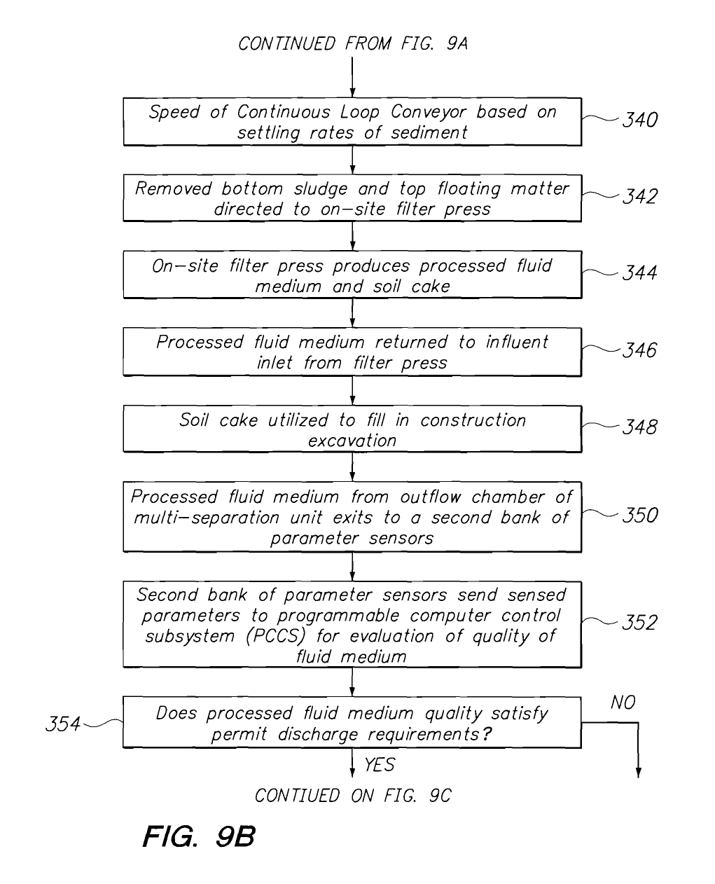

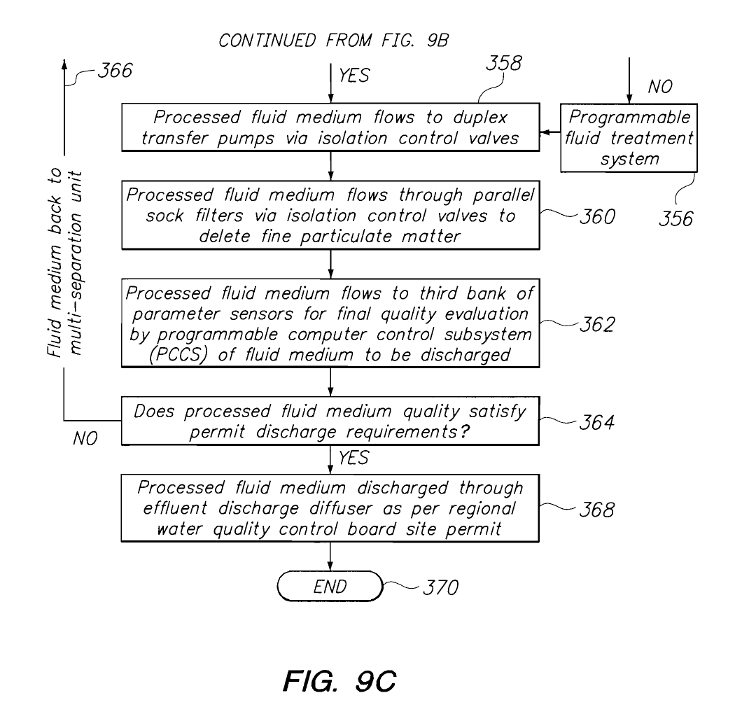

A detailed discussion of the mechanical subsystem 104 will now be introduced prior to discussing the programmable computer control subsystem (PCCS) 106 and the operation of the construction de-watering high volume, multi-separation system 100 as disclosed in the flow diagram shown in FIGS. 9A-9C. The objective of the present invention is the removal of debris, trash, large objects, gravel, sediments {sand, silt, clay, dirt}, metals, oils, greases and other chemical compounds from the fluid medium 102 located at and removed from construction sites to meet the discharge requirements of the Regional Water Quality Control Board. The definition of the term “de-watering” as used in this patent application is the removal of the fluid medium 102 from any source such as, for example, a construction site, a pit, pond, lake, river or any other source. The mechanical subsystem 104 is shown separate from but electrically connected to the programmable computer control subsystem (PCCS) 106 in FIGS. 1 and 2. A detailed view of the mechanical subsystem 104 is shown in FIGS. 3A-3B and reference to these drawings should be made during this portion of the discussion.

In the preferred embodiment of the present invention, it is presumed that the fluid medium 102 shown as the “High Volume Influent Inlet” on the upper left corner of FIG. 3A is a fluid medium 102 flooding a construction site and containing foreign matter such as, for example, sediment, targeted compounds, and floating contamination. The sediment may include sand, silt, clay, and dirt, while targeted compounds may include residual chemical compounds such as those found at construction sites. Further, floating contamination may include light floating particles from construction sites. However, it is understood that the present invention will find utility in processing fluid mediums 102 other than construction de-watering projects.

It is required by the Regional Water Quality Control Board that this foreign matter be removed from the fluid medium 102 prior to discharge into the surrounding streams, lakes, and rivers. Consequently, local, state and federal regulations now exist specifically defining the required condition and quality that the fluid medium 102 must meet prior to being discharged into surface waters. In particular, the regulations specify what compounds and foreign matter must be extracted, e.g., may not be present in the fluid medium 102 that is discharged into the surrounding surface fluid medium. The present invention addresses these requirements by providing a construction de-watering high volume, multi-separation system 100 that continuously monitors the relevant sensed parameters 108 of the fluid medium 102 and the components of the construction de-watering high volume, multi-separation system 100 to ensure the extraction and removal of the sediment, compounds, floating contamination, and other materials from the processed fluid medium 102 prior to off-site discharge in accordance with these requirements.

The mechanical subsystem includes a high volume inlet 120 labeled as the “high volume influent inlet” which receives the captured fluid medium 102 (such as dirty ground water) located at a construction site (not shown). In particular, the fluid medium 102 is typically present at construction sites such as, for example, bridge construction during installation of structural supporting components such as pylons, or other below grade construction sites. In large construction projects in which below grade excavation is required such as setting support footings in foundations, the fluid medium 102 (such as ground water) will accumulate. The fluid medium 102 must be evacuated before the concrete, for example, for the support footings can be poured and cured. The present invention is employed to remove the sediment, chemical compounds and floating contamination from the fluid medium 102 after the fluid medium 102 has been evacuated from the construction site.

The fluid medium 102 which is pumped from commercial and industrial sites is collected and routed via the high volume inlet 120 to a large debris filter stage. The large debris filter stage is comprised of a self-cleaning debris screen 122, a debris transfer auger 124, and a debris holding bin 126 as shown on FIG. 3A. The self-cleaning debris screen 122 removes trash and large items from the influent, e.g., from the fluid medium 102, which is then transferred by the debris transfer auger 124 to the debris holding bin 126. The debris transfer auger 124 can be motor-operated and can move the large debris by gravity flow with the fluid medium 102 into the debris screen 122. The motor associated with the debris transfer auger 124 can include a (4-20) milliamp communication line 140 from the transfer auger 124 for carrying sensed parameters 108 to the programmable computer control subsystem (PCCS) 106 for controlling the operation of the transfer auger 124. The removed debris is held in the holding bin 126 for off-site disposal. Although the large debris is filtered out, the fluid medium 102 including the sediment 112, targeted compounds 114, and fine floating contamination 126 pass through the debris screen 122. The self-cleaning feature of the debris screen 122 can be provided by a motorized self-cleaning wiper arm (not shown).

The fluid medium 102 is then directed from the debris screen 122 to the first duplex transfer pumping station 128 comprised of (1) a first transfer pump 130 flanked by a pair of isolation control valves 132 and 134, and (2) a second transfer pump 136 also flanked by a pair of isolation control valves 138 and 139. The duplex pump arrangement is intended to provide redundancy and it is to be understood that only one of the first transfer pump 130 or the second transfer pump 136 operates at any one time. Each of the first transfer pump 130 and the second transfer pump 136 as well as their corresponding isolation control valves 132, 134, and 138, 139, respectively, are controlled by the programmable computer control subsystem (PCCS) 106. Note that each of these components is directly connected to the programmable computer control subsystem (PCCS) 106 by a (4-20) milliamp communication line 140 for the transmission of sensed parameters 108 and the receipt of correction signals 110. Further, note that the isolation control valves 132 and 134 each include a “black dot” formed on the valve symbol which indicates that those valves are closed. Thus, in this particular example, isolation control valves 132 and 134 are closed and isolation control valves 138 and 139 are open indicating that the second transfer pump 136 is operative. Downstream of the isolation control valve 139 associated with the second transfer pump 136 is an influent sample outlet 141 including an isolation control valve 143 which can be utilized for drawing a sample of the fluid medium 102. The isolation control valve 143 is also connected to and controlled by the programmable computer control subsystem (PCCS) 106 as is indicated by the (4-20) milliamp communication line 140 for carrying the sensed parameters 108.

The filtered influent, e.g., the fluid medium 102, including the solution of sediment, 112, targeted compounds 114, and fine floating contamination 116 is pumped through the mechanical subsystem 104 by the first duplex pump station 128 to a first bank of parameter sensors 142. The first bank of parameter sensors 142 includes instruments that collect real time measurements of the sensed parameters 108 including but not limited to temperature, pH level, conductivity, turbidity, flow rate/totalizer, resistivity, and residual chemical concentrations. These measurements of the sensed parameters 108 are made at several locations throughout the construction de-watering high volume, multi-separation system 100 and are reported to the programmable computer control subsystem (PCCS) 106 for evaluation and comparison with a plurality of pre-programmed data for generating the plurality of correction signals 110. The first bank of parameter sensors 211 is connected to and controlled by the programmable computer control subsystem (PCCS) 106 as is indicated by the (4-20) milliamp communication line 140 in FIG. 3A for carrying the sensed parameters 108.

The fluid medium 102 is then directed to a flocculation tank 144 and a pH adjustment chemical tank 146 as shown in FIG. 3A. Associated with the flocculation tank 144 is a first chemical metering pump 148 which is utilized to pump a flocculant mix into a multi-separation unit 150. Likewise, associated with the pH adjustment chemical tank 146 is a second chemical metering pump 152 which is utilized to pump a pH adjustment chemical into the multi-separation unit 150 for adjusting the pH level of the fluid medium 102. The pH level is a measurement of the level of acidity and/or alkalinity of the fluid medium 102. The possible range of pH measurement is on a scale of 1-14 where the measurement range of from 1-7 indicates that the fluid medium 102 is acidic while the measurement range of from 8-14 indicates that the fluid medium 102 is basic (alkaline). The pH range of from 7-8 is a neutral range. The first chemical metering pump 148 and the second chemical metering pump 152 also are each connected to and controlled by the programmable computer control subsystem 106 by a (4-20) milliamp communication line 140 for communicating the sensed parameters 108 and correction signals 110 there across.

The programmable computer control subsystem (PCCS) 106 shown on FIG. 3A receives the plurality of sensed parameters 108 from the first bank of parameter sensors 142 and utilizes this data to compare to pre-programmed data for creating the correction signals 110. Adjacent to and mechanically connected to the programmable computer control subsystem (PCCS) 106 is a rainfall totalizer 154. The function of the rainfall totalizer 154 is to collect rainfall and provide data to the programmable computer control subsystem (PCCS) 106 for actuating the construction de-watering high volume, multi-separation system 100 into operational mode. The rainfall totalizer 154 functions as a switch to activate the programmable computer control subsystem (PCCS) 106. Additionally, a drain line 156 and a corresponding isolation control valve 158 extend from the bottom of the rainfall totalizer 154 to carry away any escaping moisture. The isolation control valve 158 is also controlled by the programmable computer control subsystem (PCCS) 106 as is evidenced by the direct connection of the (4-20) milliamp communication line 140 for delivering the sensed parameters 108 thereto.

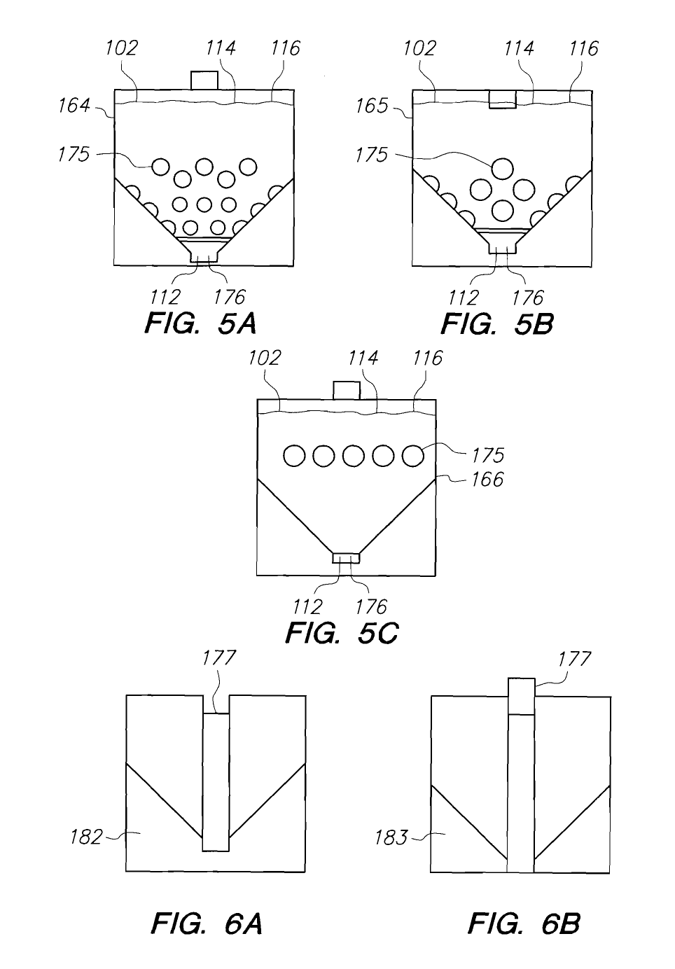

The fluid medium 102 is then directed to the multi-separation unit 150 shown in FIG. 3B. The multi-separation unit 150 is a V-shaped structure as is shown in FIGS. 5A through 5C having four separate chambers, such as, a first chamber 160, a second chamber 161, a third chamber 162, and a fourth chamber 163 each separated by a corresponding baffle partition, i.e., first, second and third baffle partitions 164, 165 and 166, respectively, as shown in FIG. 3B. The baffle partitions 164, 165, and 166 create a tortuous pathway for the fluid medium 102 to assist in causing the sediment 112 to settle to the bottom of the multi-separation unit 150. The influent, e.g., the fluid medium 102, flows into the first chamber 160 of the multi-separation unit 150 where mixing and aeration of the flocculants and pH additives and the fluid medium 102 occurs. The combination of the flocculants and pH additives are referred to hereinafter as the engineered chemicals 167. The first chamber 160 is injected with a mix of the engineered chemicals 167 for separating out the targeted compounds 114 and for controlling the pH level of the fluid medium 102. The inventive structure associated with this effort is the flocculation tank 144, first chemical metering pump 148, pH adjustment chemical tank 146, and the second chemical metering pump 152. The mix of engineered chemicals 167 is shown being injected into the multi-separation unit 150 on influent line or header 168 in FIG. 3B.

The mixing and aeration of the engineered chemicals 167 and the fluid medium 102 occur in the following manner. Located in the first chamber 160 of the multi-separation unit 150 is a pair of flocculant media mixers 169 (only one mixer 169 shown in FIG. 3B) having dual propellers to ensure that the engineered chemicals 167 injected into the multi-separation unit 150 are thoroughly mixed with the targeted compounds 114 present in the fluid medium 102. Aeration is accomplished by associating (1) a blower/air pump 170, and (2) a fine air bubblier 171 with the multi-separation unit 150. The fine air bubblier 171 is utilized to create fine bubbles 172 for the flocculant of the engineered chemicals 167 to attach to, that is, the fine air bubblier 171 is included for creating fine bubbles 172 for mixing with the fluid medium 102, targeted compounds 114, and engineered chemicals 167. The blower/air pump 170 functions to forcibly distribute air throughout the fluid medium 102, that is, the blower/air pump 170 serves to mix the fine bubbles 172 into the engineered chemicals 167, targeted compounds 114 within the fluid medium 102 (dirty water) flooding the construction site, and the sediment 112. The combination of the fluid medium 102, targeted compounds 114, and engineered chemicals 167 create a floating agglomeration or floating contamination 116 in the multi-separation unit 150. The fine bubbles 172 and forced air within the fluid medium 102 assist in the formation and rise of the floating agglomeration in the fluid medium 102. The floating agglomeration or floating contamination 116 rises to the top of the fluid medium 102 and is mechanically removed typically by being routed into a plurality of float drains 173 that are routed to a filter press 174. The blower/air pump 170 (and effectively the fine air bubblier 171) is also connected to and controlled by the programmable computer control subsystem (PCCS) 106 as is indicated by the (4-20) milliamp communication line 140 in FIG. 3A for carrying the sensed parameters 108.

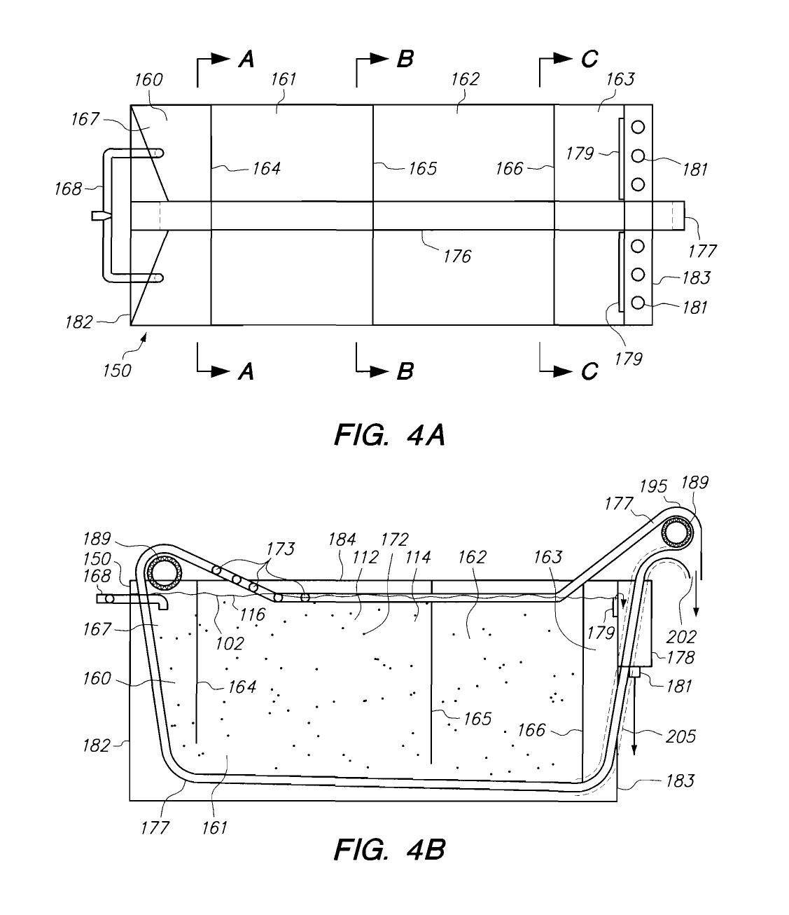

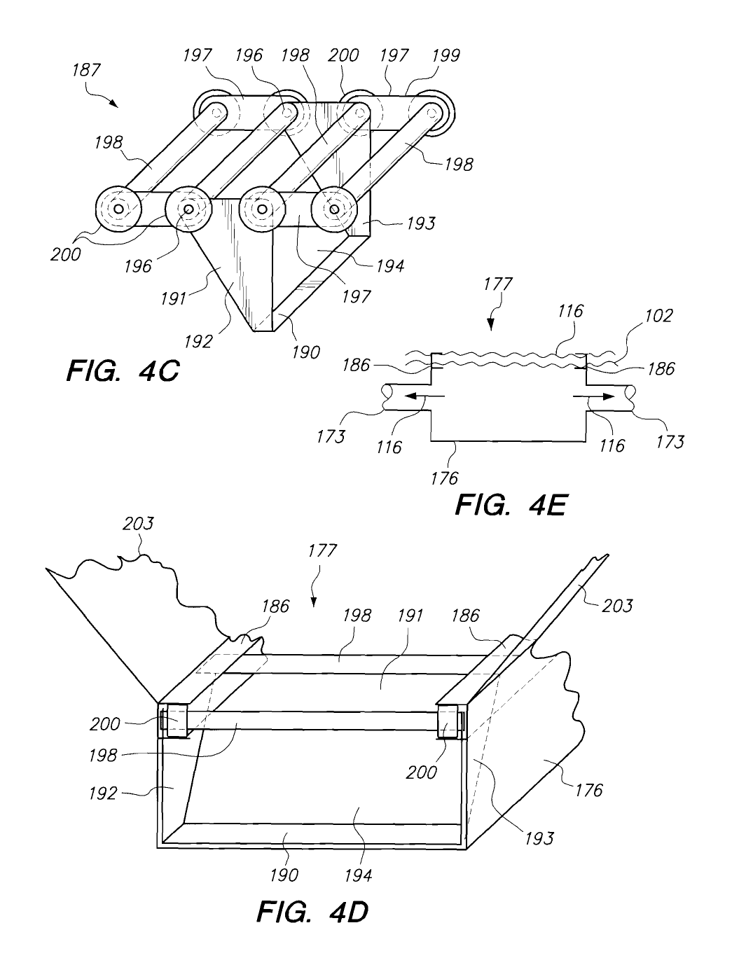

The multi-separation unit 150 includes the four chambers 160, 161, 162, and 163 which are separated by the three baffle partitions 164, 165, and 166, respectively. Each of the baffle partitions 164, 165 and 166, respectively, includes a combination of penetrations 175 which form a pattern as shown in FIGS. 5A-5C. Further, it is apparent from FIGS. 5A-5C that the multi-separation unit 150 is V-shaped, that is, the bottom of the multi-separation unit 150 is wedge-shaped or narrows the closer to the bottom of the multi-separation unit 150 one travels. Further, a review of each of the drawing FIGS. 5A, 5B and 5C shows a stationary rectangular-shaped trough 176 located in the bottom of the multi-separation unit 150. Likewise, review of the planar view of the multi-separation unit 150 shown in drawing FIG. 4A also illustrates the rectangular-shaped trough 176. The trough 176 functions to cooperate with a dual purpose continuous loop conveyor 177 employed to collect the sediment 112 that drifts downward and some of the targeted compounds 114 once treated with the engineered chemicals 167 as the fluid medium 102 travels the length of the multi-separation unit 150. Further inspection of FIG. 4A illustrates three cross-sectional lines where (1) the view along the cross-section line A-A in FIG. 4A is shown in FIG. 5A, (2) the view along the cross-section line B-B in FIG. 4A is shown in FIG. 5B, and (3) the view along the cross-section line C-C in FIG. 4A is shown in FIG. 5C.

The combination of penetrations 175 formed in each of the baffle partitions 164, 165, and 166, respectively, are positioned to enable the fluid medium 102 (typically, dirty water), engineered chemicals 167, and sediment 112 to pass through the respective baffle partition as the fluid medium 102 travels the length of the multi-separation unit 150. Typically, the pattern of penetrations 175 is located near the bottom of the V-shape or wedge-shape as is shown in FIG. 5A for baffle partition 164, and shown in FIG. 5B for baffle partition 165. The baffle partitions 164 and 165 are partially open at the bottom to enable passage of the fluid medium 102 there through. However, the pattern of penetrations 175 exhibited in FIG. 5C is positioned closer to the top of baffle partition 166 to direct the fluid medium 102 to an outflow chamber box 178 shown in FIGS. 3B and 4B. The baffle partition 166 between chambers 162 and 163 is closed at the bottom (unlike those of baffle partitions 164 and 165) to force the mud-like sediment 112 out of the chamber 163 on the continuous loop conveyor 177 at the output section of the multi-separation unit 150.

In this stage, the fluid medium 102 having been treated by the engineered chemicals 167, is now being striped of the targeted compounds 114 of concern and flows through the first chamber 160, second chamber 161, and third chamber 162 and the corresponding baffle partitions 164, 165 and 166, on the way to the fourth chamber 163 as shown in FIGS. 3B and 4B. This is the section of the construction de-watering process where settling and flotation of the targeted compounds 114 and floating contamination 116 occurs. The attachment of the engineered chemicals 167 to the targeted compounds 114 and fine bubbles 172 results in the formation of a “froth” which rises to the top of the fluid medium 102 along with the fine floating contamination 116 or agglomeration within the multi-separation unit 150. The chemical combination resident within the fluid medium 102 follows the tortuous path through and under the baffle partitions 164, 165, and 166 through each of the chambers 160, 161, 162, and 163 as shown in FIGS. 3B and 4B.

Referring to FIGS. 3B, 4A, and 4B, an adjustable overflow weir 179 is shown positioned at the top of the fourth chamber 163 of the multi-separation unit 150. At this point in the de-watering process, the fluid medium 102 has now had the targeted compounds 114 and the floating contamination 116 removed as it enters the fourth chamber 163 and flows over the adjustable overflow weir 179. The overflow weir 179 is mechanically adjustable for adjusting the level of the fluid medium 102 in the multi-separation unit 150 of the construction de-watering high volume, multi-separation system and method 100. The purpose of the adjustable overflow weir 179 is to maintain the level of the fluid medium 102 at approximately the level of the plurality of float drains 173 to facilitate the interception and carrying away of any floating contamination 116 or agglomeration riding on the top of the fluid medium 102. In this manner, any floating contamination 116 riding on the fluid medium 102 at the top of the multi-separation unit 150 will be shunted off to the float drains 173 and ultimately to the filter press 174. Once the fluid medium 102 reaches the fourth chamber 163 of the multi-separation unit 150, it flows over the overflow weir 179, into the outflow chamber box 178, and out an effluent outflow 181 as shown in FIGS. 3B, 4A, and 4B.

Located in the outflow chamber box 178 shown on FIG. 3A is a duplex level switch 180 that functions as a safety to the flow control within the multi-separation unit 150 of the construction de-watering high volume, multi-separation system 100. In particular, the duplex level switch 180 is a liquid level control device positioned within the outflow chamber box 178 and functions as a liquid level flow control mechanism. If the level of the processed fluid medium 102 within the outflow chamber box 178 begins to fill up or back up indicating an excess of fluid medium 102 and possible flooding, the duplex level switch 180 serves to de-energize the first duplex pump station 128 and the corresponding first and second transfer pumps 130 and 136 shown on FIG. 3A. This novel design prevents the transfer pumps 130 or 136 from continuing to pump the fluid medium 102 into the outflow chamber box 178 to avoid an overflow condition. The duplex level switch 180 also terminates the operation of the high volume inlet 120 to further guard against an accidental overflow condition. The duplex level switch 180 is also connected to and controlled by the programmable computer control subsystem (PCCS) 106 as is indicated by the (4-20) milliamp communication line 140 in FIG. 3A for carrying the sensed parameters 108.

FIG. 6A and FIG. 6B illustrate the end views of the multi-separation unit 150 of the construction de-watering high volume, multi-separation system and method 100 of the present invention. In particular, FIG. 6A illustrates a left end view of the input section of the multi-separation unit 150 viewing the first chamber 160 as shown in FIGS. 4A and 4B. FIG. 6A shows a left side of the housing structure 182 of the multi-separation unit 150 illustrating a section of the continuous loop conveyor 177. Likewise, FIG. 6B shows a right side of the housing structure 183 of the multi-separation unit 150 also illustrating a section of the continuous loop conveyor 177.

The design of the multi-separation unit 150 creates a slow tortuous path for the fluid medium 102 to pass through which promotes (1) the slow decent of the sediment 112 and treated targeted compounds 114 (i.e., sludge) to the bottom of the trough 176, and (2) the rise of the floating contamination 116 or agglomeration to the top of the multi-separation unit 150. The compounds to be removed from the fluid medium 102 (e.g., sediment 112, targeted compounds 114, and floating contamination 116) settle to (1) the bottom of the multi-separation unit 150 in the trough 176, and also (2) float to the top of the multi-separation unit 150, known in the industry as “bottom sludge” and “top float”. These compounds are removed via the dual purpose continuous loop conveyor 177 shown in FIGS. 3B and 4B, but illustrated the best in FIGS. 4C and 4D. The stationary trough 176 extends the entire length of the multi-separation unit 150 as shown in FIG. 4A. The dual purpose sludge/float continuous loop conveyor 177 cooperates with the trough 176 and tracks along the length of the trough 176, the left side of the housing structure 182, the top of the housing structure 184, and the right side of the housing structure 183. Thus, the conveyor 177 forms a continuous loop around the multi-separation unit 150 as shown in FIGS. 3B and 4B. The construction of the continuous loop conveyor 177 includes a pair of raceway channels 186 formed in the stationary trough 176 through which a plurality of rolling conveyor buckets 187 are pulled by a duplex conveyor drive unit 188 and a pair of sprocket wheels 189 as is shown in FIGS. 3B, 4B, 4C, and 4D. The entire construction of the continuous loop conveyor 177 is fashioned from metal such as steel.

The following description is directed to the structure shown on FIGS. 4C and 4D. One of the rolling conveyor buckets 187 is shown in perspective in FIG. 4C and includes a V-shaped construction having three sides of solid construction. The V-shape of the conveyor bucket 187 includes (1) a solid flat bottom 190, (2) a solid rear wall 191, and (3) two solid V-shaped sidewalls 192 and 193. The front of the V-shaped rolling conveyor bucket 187 is an “open window” 194 utilized to capture sediment 112 and some targeted compounds 114 (typically referred to as “mud”) when the conveyor bucket 187 skims the bottom of the trough 176. Further, when each of the rolling conveyor buckets 187 is pulled up the right side of the housing structure 183 (shown in FIGS. 3B and 4B) to an inversion point 195 in the continuous loop conveyor 177, each of the conveyor buckets 187 rotates upside-down so that the “open window” 194 can capture the floating contamination 116 present in the fluid medium 102 at the top of the multi-separation unit 150. Both of the solid V-shaped sidewalls 192 and 193 of the rolling conveyor buckets 187 shown in FIG. 4C includes penetrations 196 therein for cooperatively attaching to corresponding components. Distances between the penetrations 196 are all equal for measurement purposes.

The corresponding components associated with the rolling conveyor buckets 187 include a plurality of link plates 197 which are utilized to (a) maintain equal distances between a plurality of spreader bars 198 so that the sprocket wheels 189 move the continuous loop conveyor forward, and (b) to allow flexible movement of a drive chain 199 formed by a series of link plates 197 as shown in FIG. 4C. It is estimated that there are approximately five link plates 197 positioned between adjacent rolling conveyor buckets 187. Each of the plurality of spreader bars 198 is utilized to (1) maintain a fixed distance across each of the rolling conveyor buckets 187, (2) to maintain the width of the drive chain 199, and (3) to create the contact point with the pair of sprocket wheels 189 shown best on FIG. 4B. Each of the rolling conveyor buckets 187 is fitted with four roller wheels 200 which are utilized for reducing the friction of the rolling conveyor bucket 187 as it travels through the rectangular shaped raceway channel 186. The roller wheels 200 of the conveyor buckets 187 roll on the inside of the steel raceway channels 186 mounted within the stationary trough 176. The roller wheels 200 can ride in the raceway channels 186 on the inside of the stationary trough 176 while the bottom surface of the rolling conveyor bucket 187 skims the bottom of the trough 176 to scoop up sludge in the form of sediment 112 and certain targeted compounds 114. The sludge has the consistency of “mud” which is carried very slowly in the rolling conveyor buckets 187 along the continuous loop conveyor 177 to the inversion point 195 where the sludge is dumped into a discharge chute 202 directed to the filter press 174.

During operation, the pair of sprocket wheels 189 have teeth (not shown) that catch the spreader bars 198 that are incorporated in the drive chain 199 for advancing the rolling conveyor buckets 187 forward. Once the rolling conveyor bucket 187 or the next spreader bar 198 located in the drive chain 199 is advanced forward, the tooth on the sprocket wheel 189 falls off of the spreader bar 198. Thereafter, the next spreader bar 198 in line is engaged by the sprocket tooth on the sprocket wheel 189 to further advance the drive chain 199 for moving the conveyor buckets 187 forward. It is the continuous loop of link plates 197, rolling conveyor buckets 187, and spreader bars 198 that form the drive chain 199 for providing the continuous loop conveyor 177. The entire drive chain 199 is driven by the pair of sprocket wheels 189 located at the top of the continuous loop conveyor 177 shown in FIG. 4B. The continuous loop conveyor 177 is, in turn, driven by the duplex conveyor drive unit 188.

The roller wheels 200 of the rolling conveyor bucket 187 are shown positioned on the raceway channels 186 and the conveyor bucket 187 is shown passing through the trough 176 in FIG. 4D. The pair of raceway channels 186 are shown affixed to the top inside surface of the trough 176 for accommodating the roller wheels 200 of the rolling conveyor bucket 187. The components of the rolling conveyor bucket 187 are clearly shown including the solid flat bottom 190, solid rear wall 191, solid V-shaped sidewalls 192 and 193, the “open window” 194, the spreader bars 198, and the roller wheels 200. Also shown are portions of the inclined sidewalls 203 of the multi-separation unit 150 on which the combination of sediment 112 and portions of the targeted compounds 114, collectively known as sludge, flows or slides down into the trough 176 at the bottom of the multi-separation unit 150. It is to be understood that the trough 176 is part of the fixed structure of the multi-separation unit 150 and does not move. It is the rolling conveyor buckets 187 that move within the trough 176, that is, the rolling conveyor buckets 187 move on the roller wheels 200 in the pair of steel raceway channels 186 affixed within the stationary trough 176. The rolling conveyor bucket 187 as shown in FIG. 4D is intended to skim along the bottom of the trough 176 to scoop up the heavy mud sludge (e.g., sediment 112 and some targeted compounds 114 that have been treated with the engineered chemicals 167). The rolling conveyor buckets 187 also will capture the fine floating contamination and froth at the top of the multi-separation unit 150.

Now referring to FIG. 4B and picture the illustration shown in FIG. 4D, the pair of sprocket wheels 189 cooperate with each of the plurality of spreader bars 198 shown in FIGS. 4C-4D to pull each of the rolling conveyor buckets 187 through the trough 176. The “open window” 194 of the construction of the rolling conveyor buckets 187 enables the collection, scooping-up, and carrying away of the sludge (e.g., sediment 112 and certain treated targeted compounds 114) without the spillage thereof. The portion of the continuous loop conveyor 177 traveling up an inclined surface 204 that intersects with the right side of the housing structure 183 of the multi-separation unit 150, may result in spillage of the sludge (e.g., sediment 112 and certain treated targeted compounds 114). In order to avoid this problem, that portion of the continuous loop conveyor 177 that extends up the inclined surface 204 (see FIG. 3B) is carried up through an enclosed inclined surface 205 (see FIG. 4B) to prevent the sludge from escaping from the rolling conveyor buckets 187. The rolling conveyor buckets 187 carrying the heavy sludge load (e.g., sediment 112 and certain treated targeted compounds 114) are pulled up through the enclosed inclined surface 205 to the sprocket wheels 189.

When the rolling conveyor buckets 187 reach the top of the enclosed inclined surface 205, each rolling conveyor bucket 187 passes the inversion point 195 as is best shown in FIG. 4B. The inversion point 195 is the point at which the continuous loop conveyor 177 reverses direction. Each of the rolling conveyor buckets 187 exits the top of the enclosed inclined surface 205 and the trajectory of the continuous loop conveyor 177 is directed downward. However, the pair of sprocket wheels 189 continue to pull the spreader bars 198 of the rolling conveyor buckets 187 upward over the sprocket wheel 189. This action causes each rolling conveyor bucket 187 to reverse direction so that the heavy sludge load (e.g., sediment 112 and certain treated targeted compounds 114) and residual fluid medium 102 gravity fall into the discharge chute 202 shown in FIGS. 3B and 4B leading to the filter press 174 where the sludge load is processed for disposal. The newly emptied rolling conveyor bucket 187 is then pulled back over the top of the sprocket wheels 189 in an upside-down position so that the rolling conveyor bucket 187 is now positioned to intercept and capture the floating contamination 116 or agglomeration floating in the fluid medium 102 at the top of the multi-separation unit 150.

The rolling conveyor buckets 187 continue to be pulled through the continuous loop conveyor 177 comprising a steel construction which includes the raceway channels 186. The continuous loop conveyor 177 implies that conveyor 177 surrounds the entire multi-separation unit 150 as shown in FIGS. 3B and 4B. Once the rolling conveyor buckets 187 are pulled past the inversion point 195 and the sprocket wheels 189, the upside-down empty rolling conveyor buckets 187 are positioned for intercepting and capturing the floating contamination 116 through the “open window” 194 shown in FIGS. 4C and 4D. The floating contamination 116 is intercepted and captured through the “open window” 194 in the froth and carries the floating contamination 116 to the plurality of float drains 173 which also leads to the filter press 174.

Reference should now be made to FIG. 4E which illustrates the construction of portions of the continuous loop conveyor 177 and the relationship to the float drains 173. FIG. 4E is very similar to FIG. 4D, however, the rolling conveyor bucket 187 shown in FIG. 4D does not appear in FIG. 4E. The illustration in FIG. 4E shows a cross-sectional view of the continuous loop conveyor 177 along the line A-A shown on FIG. 4A. This sectional view is located at the situs of the plurality of float drains 173 shown on FIG. 4B. The essence of FIG. 4E is the construction showing the permanent connection of the float drains 173 to the stationary trough 176. The float drains 173 are located at the top of the multi-separation unit 150 where the floating contamination 116 or agglomeration is located. A single float drain 173 is shown connected to the trough 176 in FIG. 4E. Also shown is the pair of raceway channels 186 for accommodating the roller wheels 200 of the rolling conveyor bucket 187 if one were shown. The level of the fluid medium 102 is controlled by the mechanically adjustable overflow weir 179 shown in FIGS. 3B and 4B to be maintained at the level of the float drains 173. This level of the fluid medium 102 facilitates the capture of the floating contamination 116 located at the top of the multi-separation unit 150 through the float drains 173.

As the rolling conveyor buckets 187 are pulled through the trough 176 by the sprocket wheels 189, the “open window” 194 captures floating contamination 116. Simultaneously, as the rolling conveyor buckets 187 are pulled forward, a pressure is applied to the fluid medium 102 resident within the trough 176. Because the open float drains 173 represent an escape path, the fluid medium 102 including the fine floating contamination 116 passes through the open float drains 173. The open float drains 173 which are carrying the floating contamination 116 including froth and agglomerated mass generated by use of the engineered chemicals 167 are routed directly to the filter press 174. In this manner, the floating contamination 116 is eliminated. Simultaneously, the processed clear fluid medium 102 that is now passing through the fourth chamber 163 of the multi-separation unit 150 flows over the adjustable overflow weir 179 and into the outflow chamber box 178, and out an effluent outflow 181 as shown in FIGS. 3B, 4A, and 4B.

The sludge (e.g., sediment 116 and certain targeted compounds 114) and the floating contamination 116 are both directed to the filter press 174. The sludge (e.g., sediment 116 and certain targeted compounds 114) arrives at the filter press 174 via the discharge chute 202. Likewise, the floating contamination 116 arrives at the filter press 174 via the plurality of float drains 173 on a line 206 as shown in FIG. 3B. In the filter press 174, the sludge (e.g., sediment 116 and certain targeted compounds 114) is pressed to remove any fluid which is recycled back to the multi-separation unit 150. The recycled fluid is pumped via a transfer pump 207 on a line 208 back to the influent inlet at the injection line or header 168 for the multi-separation unit 150 shown on FIGS. 3B and 4B. The transfer pump 207 is also connected to and controlled by the programmable computer control subsystem (PCCS) 106 as is indicated by the (4-20) milliamp communication line 140 in FIG. 3A for carrying the sensed parameters 108. The resulting mud or sludge (e.g., sediment 116 and certain targeted compounds 114) is pressed into soil cakes 209 and can be utilized for soil repatriation or disposed of off-site. Although the flocculants of the engineered chemicals 167 attach to the sediment 112, targeted compounds 114, and the floating contamination 116, most of the engineered chemicals 167 are disposed of down the discharge chute 202 to the filter press 174. Sediment 112 is a component of the soil cake 209. However, the flocculants/engineered chemicals 167 are inert (e.g., non-reactive) and thus are not harmful when appearing in the soil cake 209.

The clear processed fluid medium 102 is directed from the effluent outflow 181 of the outflow chamber box 178 to both a sample valve 210 and a second bank of parameter sensors 211 as shown on FIG. 3B. The sample valve 210 is a motor controlled valve that is remotely controlled from the programmable computer control subsystem (PCCS) 106. The second bank of parameter sensors 211 is positioned so as to evaluate the quality of the clear processed fluid medium 102 from the multi-separation unit 150. Similar to the function of the first bank of parameter sensors 142, the second bank of parameter sensors 211 includes instruments that collect real time measurements of the sensed parameters 108 including but not limited to temperature, pH level, conductivity, turbidity, flow rate/totalizer, resistivity, and residual chemical concentrations. These measurements of the sensed parameters 108 are made at several locations throughout the construction de-watering high volume, multi-separation system 100 and are reported to the programmable computer control subsystem (PCCS) 106 for evaluation and comparison with a plurality of pre-programmed data for generating the plurality of correction signals 110. Both the sample valve 210 and the second bank of parameter sensors 211 are connected to and controlled by the programmable computer control subsystem (PCCS) 106 as is indicated by the (4-20) milliamp communication line 140 in FIG. 3B for carrying the sensed parameters 108.

The results of the evaluation of the processed fluid medium 102 by the second bank of parameter sensors 211 determines the next step in the construction de-watering process. At this stage, the clean effluent or clean fluid medium 102 can now be directed to pass through the Programmable Fluid Treatment System And Method 212 via a motor controlled valve 213 for additional chemical processing as shown in FIG. 3B if the quality of the fluid medium 102 exiting the multi-separation unit 150 does not meet the standards of the Regional Water Quality Control Board. The Programmable Fluid Treatment System And Method 212 is described in U.S. patent application Ser. No. 13/610,800 filed on Sep. 11, 2012, is directed to related subject manner, and is hereby incorporated by reference in it's entirety. The motor controlled valve 213 is also connected to and controlled by the programmable computer control subsystem (PCCS) 106 as is indicated by the (4-20) milliamp communication line 140 in FIG. 3B for carrying the sensed parameters 108. Once the fluid medium 102 exits the Programmable Fluid Treatment System and Method 212, the fluid medium 102 is directed to a second duplex transfer pumping station 214 as shown on FIG. 3A. In the alternative, if the quality of the fluid medium 102 exiting the multi-separation unit 150 does meet the standards of the Regional Water Quality Control Board, the fluid medium 102 can avoid the Programmable Fluid Treatment System And Method 212 by utilizing a bypass line 215 located between the motor controlled valve 213 and the second duplex transfer pumping station 214.

The second duplex transfer pumping station 214 is comprised of (1) a first transfer pump 216 flanked by a pair of isolation control valves 217 and 218, and (2) a second transfer pump 219 also flanked by a pair of isolation control valves 220 and 221. The duplex pump arrangement is intended to provide redundancy and it is to be understood that only one of the first transfer pump 216 or the second transfer pump 219 operates at any one time. Each of the first transfer pump 216 and the second transfer pump 219 as well as their corresponding isolation control valves 217, 218, and 220, 221, respectively, are controlled by the programmable computer control subsystem (PCCS) 106. Note that each of these components is directly connected to the programmable computer control subsystem (PCCS) 106 by a (4-20) milliamp communication line 140 for the transmission of sensed parameters 108 and the receipt of correction signals 110. Further, note that the isolation control valves 217 and 218 each include a “black dot” formed on the valve symbol which indicates that these valves are closed. Thus, in this particular example, isolation control valves 217 and 218 are closed and isolation control valves 220 and 221 are open indicating that the second transfer pump 219 is operative. The programmable computer control system (PCCS) 106 controls which parallel transfer pump-isolation control valve combination is utilized. For example, one of the parallel transfer pump-isolation control valve combinations may be clogged, or out of service for scheduled maintenance, or cycled to “off” according to an operational schedule.

The processed effluent or fluid medium 102 is next directed to a duplex security sock filter bank 222 for filtering out stray particulate matter. The processed fluid medium 102 enters a T-joint 223 where it flows either to (a) a first sock filter 224 flanked by a pair of isolation control valves 225 and 226, or to (b) a second sock filter 227 flanked by another pair of isolation control valves 228 and 229. The purpose of the isolation control valves 225, 226, and 228, 229 is to isolate each of the first and second sock filters 224 and 227, respectively, so that only one side of the sock filter bank 222 is operative at a time. The design of the duplex sock filter bank 222 is intended to provide redundancy and it is to be understood that only one of the first sock filter 224 or the second sock filter 227 operates at any one time. Each of the first sock filter 224 and the second sock filter 227 as well as their corresponding isolation control valves 225, 226, and 228, 229, respectively, are controlled by the programmable computer control subsystem (PCCS) 106. Note that each of these components is directly connected to the programmable computer control subsystem (PCCS) 106 by a (4-20) milliamp communication line 140 for the transmission of sensed parameters 108 and the receipt of correction signals 110. Further, note that the isolation control valves 225 and 226 each include a “black dot” formed on the valve symbol which indicates that these valves are closed. Thus, in this particular example, isolation control valves 225 and 226 are closed and isolation control valves 228 and 229 are open indicating that the second sock filter 227 is operative.

The programmable computer control system (PCCS) 106 controls which parallel sock filter-isolation control valve combination is utilized. For example, one of the parallel sock filter-isolation control valve combinations may be clogged, or out of service for scheduled maintenance, or cycled to “off” according to an operational schedule. Each of the parallel first sock filter 224 and second sock filter 227 is typically a polyester fabric filter that is employed to filter out any remaining stray particulate matter in the processed fluid medium 102. The use of the duplex security sock filter bank 222 is required by the Regional Water Quality Control Board to ensure that the processed fluid medium 102 is sufficiently clean prior to surface water discharge to streams, lakes and rivers. Also included is a differential pressure switch 230 installed across the duplex security sock filter bank 222 for measuring the differential pressure from the input T-joint 223 to the output of the two isolation control valves 226 and 229. The differential pressure switch 230 is also connected to and controlled by the programmable computer control subsystem (PCCS) 106 as is indicated by the (4-20) milliamp communication line 140 extending from the differential pressure switch 230 in FIG. 3A for carrying the sensed parameters 108. When the differential pressure sensed by the differential pressure switch 230 reaches a certain value, the programmable computer control subsystem (PCCS) 106 switches the flow of the fluid medium 102 to the opposite sock filter to avoid fouling thereof.

The processed fluid medium 102 is then delivered to a third bank of parameter sensors 231 as shown on FIG. 3A. The third bank of parameter sensors 231 is positioned so as to evaluate the quality of the clear processed fluid medium 102 from the duplex security sock filter bank 222. Similar to the functions of the first bank of parameter sensors 142 and the second bank of parameter sensors 211, the third bank of parameter sensors 231 includes instruments that collect real time measurements of the sensed parameters 108 including but not limited to temperature, pH level, conductivity, turbidity, flow rate/totalizer, resistivity, and residual chemical concentrations. These measurements of the sensed parameters 108 are made at several locations throughout the construction de-watering high volume, multi-separation system 100 and are reported to the programmable computer control subsystem (PCCS) 106 for evaluation and comparison with a plurality of pre-programmed data for generating the plurality of correction signals 110. The third bank of parameter sensors 211 are connected to and controlled by the programmable computer control subsystem (PCCS) 106 as is indicated by the (4-20) milliamp communication line 140 extending from the third bank of parameter sensors 231 in FIG. 3A for carrying the sensed parameters 108.

Immediately downstream of the third bank of parameter sensors 231 is an effluent sample valve 232 employed for obtaining a sample of the clean processed fluid medium 102. The effluent sample valve 232 is a motor controlled valve that is remotely controlled from the programmable computer control subsystem (PCCS) 106. Further, the effluent sample valve 232 is connected to and controlled by the programmable computer control subsystem (PCCS) 106 as is indicated by the (4-20) milliamp communication line 140 shown extending from the effluent sample valve 232 in FIG. 3A for carrying the sensed parameters 108. In a situation in which the quality of the processed fluid medium 102 is deficient as determined by the programmable computer control subsystem (PCCS) 106 in accordance with the measurements of the third bank of parameter sensors 231, the fluid medium 102 should be re-processed. This return action is accomplished by a motor control valve 233 that re-routes the fluid medium 102 back to the injection line header 168 of the multi-separation unit 150 shown on FIGS. 3B, 4A, and 4B. The motor control valve 233 is connected to and controlled by the programmable computer control subsystem (PCCS) 106 as is indicated by the (4-20) milliamp communication line 140 extending from the motor control valve 233 in FIG. 3A for carrying the sensed parameters 108.

In a situation in which the quality of the processed fluid medium 102 is acceptable as determined by the programmable computer control subsystem (PCCS) 106 in accordance with the measurements of the third bank of parameter sensors 231, the fluid medium 102 will be discharged to surface water sources such as streams, lakes and rivers. To that end, a discharge valve 234 is positioned in the stream of the fluid medium 102 as shown in FIG. 3A. The discharge valve 234 is a motor control valve which is connected to and controlled by the programmable computer control subsystem (PCCS) 106 as is indicated by the (4-20) milliamp communication line 140 extending from the discharge valve 234 in FIG. 3A for carrying the sensed parameters 108. The discharge valve 234 controls the access of the fluid medium 102 to an effluent discharge diffuser 235. The effluent discharge diffuser 235 is typically a pipe having a 6″-to-9″ diameter including a plurality of 2″ perforations 236 formed therein. The perforations 236 have the effect of increasing the diameter area of the effluent discharge diffuser 235 by five fold. That is, the multiple discharge ports (e.g., perforations 236) increase the discharge area of the effluent discharge diffuser 235 by five fold. The purpose of including the perforations 236 is to avoid creating a high velocity flow of the fluid medium 102 at the effluent discharge diffuser 235 since a high velocity flow could cause erosion in the discharge channel in an adjacent stream, lake, river, or other body of water in which the fluid medium 102 is directed to. The discharged fluid medium 102 can become a part of a percolation pond, an evaporation pond, or become part of the existing surface water.

The construction de-watering high volume, multi-separation system 100 is controlled by the programmable computer control subsystem (PCCS) 106 that will maintain and control the operating parameters thereof. The operation of the flocculation balance of the fluid medium 102, contact time between the flocculant and the fluid medium 102, and the pH balance are critical and must be monitored and controlled on a full time basis to insure that the effluent make-up satisfies the regulatory requirements. The programmable computer control subsystem (PCCS) 106 is employed in the present invention for controlling and continuously monitoring each stage of the mechanical subsystem 104 for ensuring proper operation thereof. Each major component of the mechanical subsystem 104 is in electronic communication with the programmable computer control subsystem (PCCS) 106. In this manner, the condition of the processed fluid medium 102 will satisfy the regulations of the Regional Water Quality Control Board and the processed fluid medium 102 will be discharged to the streams, lakes, and rivers. Referring to FIGS. 1 and 2, the main components of the programmable computer control subsystem (PCCS) 106 are shown. The mechanical subsystem 104 is in electrical signal communication with the programmable computer control subsystem (PCCS) 106 as is clearly shown in FIG. 1. The programmable computer control subsystem (PCCS) 106 is housed within a National Electrical Manufacturers Association (NEMA) rated control panel enclosure 240 which contains the main components thereof. The NEMA rated control panel enclosure 240 is typically a locked enclosure located on-site at the location of the construction de-watering high volume, multi-separation system 100. The entire programmable computer control subsystem (PCCS) 106 is located within the NEMA rated control panel enclosure 240 so that it is conveniently accessible to the system engineer/programmer and the system operator.

The NEMA enclosure 240 houses a User Controllable Open System (UCOS) which includes (1) a plurality of digital/Analog Input/Output Modules 242 commonly referred to as an “input/output board rack” which is physically connected to the mechanical subsystem 104 as shown in FIG. 2. The Digital/Analog Input/Output Modules 242 are also connected to (2) a Micro-Field Control Unit (FCU) 244 within the NEMA enclosure 240. The Field Control Unit (FCU) 244 is, in turn, also connected back to the Digital/Analog Input/Output Modules 242. The Field Control Unit (FCU) 244 also has reciprocal connections with a (3) Computer Operator Workstation 246 shown within the NEMA enclosure 240 in FIG. 2. The Computer Operator Workstation 246 further has reciprocal connections with an (4) Operator Workstation Touch Screen Control (panel) 248 located within the NEMA enclosure 240. Additionally, an (5) Engineering Workstation (EWS) 250 located exterior to the NEMA enclosure 240 is physically connected to the Computer Operator Workstation 246. A (6) separate antenna 252 mounted on the NEMA enclosure 240 is also directly connected to the Computer Operator Workstation 246. Finally, an (7) Off-Site Access Terminal 254 also includes reciprocal connections with the Computer Operator Workstation 246 as shown in FIGS. 1 and 2.

As shown in FIGS. 1 and 2, the mechanical subsystem 104 is connected to the programmable computer control subsystem (PCCS) 106 via the plurality of communication lines 140. The communication lines 140 shown in FIGS. 1, 2, 3A and 3B carry (a) the plurality of sensed parameters 108 or real time monitoring signals to, and (b) the plurality of correction signals 110 from, the programmable computer control subsystem (PCCS) 106. In FIGS. 3A and 3B, the communications lines 140 are shown carrying these real time signals from various system components to and from the programmable computer control subsystem (PCCS) 106. In FIG. 1, these sensed parameters 108 or real time monitoring signals and the correction signals 110 are shown directed to and from the NEMA rated control panel enclosure 240. However, in FIG. 2, these sensed parameters 108 or real time monitoring signals and the correction signals 110 are directed to the Digital/Analog. Input/Output Modules 242.

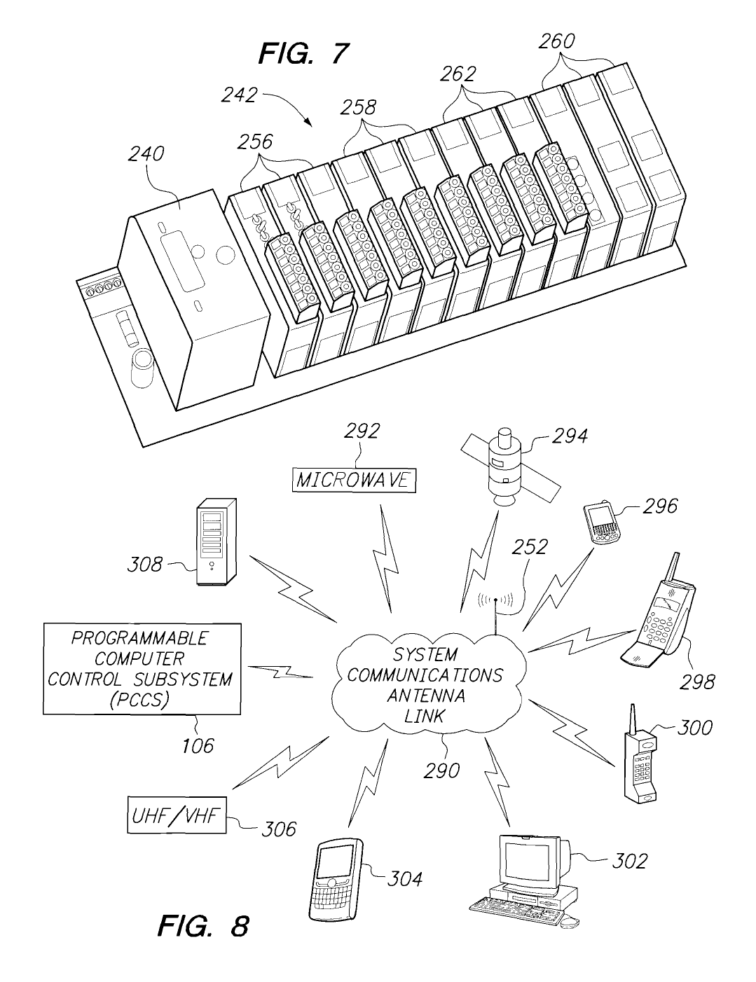

The Digital/Analog, Input/Output Modules 242 are shown in block form in FIG. 2 and as a structural component in FIG. 7. Categories of components located within the NEMA enclosure 240 in addition to the Micro-Field Control Unit (FCU) 244 include {a} a plurality of digital input modules 256, {b} a plurality of digital output modules 258, {c} a plurality of analog input modules 260, and {d} a plurality of analog output modules 262 as shown in FIG. 7. The digital input modules 256 include four isolated channels operating within the range of 2.5 volts-280 volts, AC or DC, while the digital output modules 258 comprise four isolated channels operating within the range of 5 volts-250 volts, AC or DC. Furthermore, is the analog output modules 262 include two channels that provide current, voltage or time-proportional outputs, while the analog input modules 260 comprise two isolated or four non-isolated channels that provide current, voltage, ICTD, thermocouple, rate, or RTD inputs. The function of the Digital/Analog, Input/Output Modules 242 (also referred to as the Input/Output Board Rack) shown in FIGS. 2 and 7 is to receive all the sensed parameters 108 (which are digital and analog signals) in real time. All of the digital and analog sensed parameters 108 are then routed to the Field Control Unit (FCU) 244 which is the local micro-Field Control Unit processor unit.

The Field Control Unit (FCU) 244 receives all of the digital and analog sensed parameters (signals) 108 from the Digital/Analog, Input/Output Modules 242 on a line 264. Thus, each of the sensor devices distributed throughout the mechanical subsystem 104 such as the multiple banks of parameter sensors 142, 211, and 231, periodically sense, for example, including but not limited to temperature, pH level, conductivity, turbidity, flow rate/totalizer, resistivity, residual chemical concentrations, and other parameters of the fluid medium 102. These sensed parameters 108 are transmitted to the Digital/Analog, Input/Output Modules 242 located in the programmable computer control subsystem (PCCS) 106 and are then forwarded to the Field Control Unit (FCU) 244 which is the local micro-processor unit. The Field Control Unit (FCU) 244 then proceeds to identifies the origin of each signal to determine where each sensed parameter (signal) 108 should be transmitted to in the Computer Operator Workstation 246.

Each of the received sensed parameter (signals) 108 is transmitted from the Field Control Unit (FCU) 244 to the Computer Operator Workstation 246 for processing. After suitable processing, the sensed parameters 108 (which are input signals) are transmitted back to the Field Control Unit (FCU) 244 as the correction signals 110 (which are return signals) on a line 266. The Field Control Unit (FCU) 244 then interprets where the correction signals 110 are to be transmitted back to the Digital/Analog, Input/Output Modules 242 for the ultimate return to the correct component location in the mechanical subsystem 104. In other words, the Computer Operator Workstation 246 reads the sensed parameters 108, makes adjustments and control changes and delivers, as necessary, the correction signals 110 back to the appropriate component location in the mechanical subsystem 104 to control the Construction De-Watering High Volume, Multi-Separation System 100 to meet the requirements of the Regional Water Quality Control Board. Thus, the Digital/Analog, Input/Output Modules 242 serve the input/output function as intended.

The programmable computer control subsystem (PCCS) 106 is a complete control system that includes graphical development software (not shown), a graphical human-machine interface (i.e., Operator Workstation Touch Screen Control 248), and a personal computer (PC) based logic processor (i.e., Field Control Unit FCU 244), and an Input/Output interface (i.e., Digital/Analog, Input/Output Modules 242). The programmable computer control subsystem (PCCS) 106 is all based on user-configurable, open system standards. Several of the system's distinct, yet tightly coupled components are supported which include: (1) the Engineering Workstation (EWS) 250 utilized for project development; (2) the Computer Operator Workstation (OWS) 246 utilized as an operator interface with the programmable computer control subsystem (PCCS) 106; and (3) the Field Control Unit (FCU) 244 utilized for control logic execution and direct scanning of the Input/Output data stored in the Digital/Analog, Input/Output Modules 242. These components are connected together via the Ethernet or fiber optic, redundant or non-redundant network using various protocols known in the art.

The Engineering Workstation (EWS) 250 shown on FIG. 2 is located external to the NEMA rated control panel enclosure 240 and is the development tool where control schemes are configured and downloaded to the Computer Operator Workstation (OWS) 246 and the Field Control Unit (FCU) 244. The entire project directed to, for example, the Construction De-Watering High Volume, Multi-Separation System 100, is configured using a single, integrated tool based on graphical Windows standards. Project configuration begins by defining the system architecture including workstations, field control units (FCU's), Input/Output, and networking. The developer simply selects a component for insertion into a graphical representation of the system architecture. Graphical techniques are also used to define the logical relationships among the control elements for multiple devices. The developer “drags and drops” graphical representations of device objects into a device diagram. This device diagram acts as the project's control logic which is substantially downloaded to the Field Control Unit (FCU) 244. The device diagram includes standard devices, such as PID controllers, transmitters, switches, and others. It also includes user-definable devices for pumps, valves, conveyors, etc. The project development tools also support configuration of screen and function security, grouping of command windows, logging, grouping of alarms, generation of project documentation, and more. Entire projects or configuration changes can be downloaded to the Computer Operator Workstation 246 and Field Control Unit (FCU) 244. Changes can be made online.

The Engineering Workstation (EWS) 250 is utilized by the engineering staff/programmers to program, that is, to set the parameters of the programmable computer control subsystem (PCCS) 106 for project development. The Engineering Workstation (EWS) 250 is the only location from which these system parameters can be programmed or modified and only the system engineer/programmer has access thereto. The Engineering Workstation (EWS) 250 is shown in FIG. 1 as connecting to the NEMA enclosure 240 and in FIG. 2 as connecting to the Computer Operator Workstation (OWS) 246 within the NEMA enclosure 240 via a line 268. In particular, the engineering/programming staff utilizes a separate computer at the Engineering Workstation (EWS) 250 to program and download logic code onto a computer located at the Computer Operator Workstation (OWS) 246 located within the NEMA enclosure 240 for changing parameters of the programmable computer control subsystem (PCCS) 106. The changing of parameters typically might occur when field components and/or system hardware are modified or replaced. It is emphasized that only the engineer/programmer working at the Engineering Workstation (EWS) 250 has access to the separate computer utilized by the engineer/programmer, not the operator located at the Computer Operator Workstation (OWS) 246.

It is further noted that the Engineering Workstation (EWS) 250 includes the computer that enables the engineer/programmer to program, that is, to set the parameters of the programmable computer control subsystem (PCCS) 106. The computer associated with the Engineering Workstation (EWS) 250 can be a general purpose computer of the desktop or laptop variety which contains suitable computer programs utilized solely to write the programming logic and for selecting the configuration of the programmable computer control subsystem (PCCS) 106. If necessary, the engineer/programmer located at the Engineering Workstation (EWS) 250 can control the operation of the Construction De-Watering High Volume, Multi-Separation System 100 to meet the objectives programmed into the programmable computer control subsystem (PCCS) 106. Although the Engineering Workstation (EWS) 250 is utilized to set the program logic code, the operator located at the Computer Operator Workstation (OWS) 246 can change certain settings, for example, the speed of a pump which is normally set at the Engineering Workstation (EWS) 250. Access from off-site locations (which can be any location external to the Construction De-Watering High Volume, Multi-Separation System 100), is available to communicate with the separate computer at the Computer Operator Workstation (OWS) 246 for obtaining the most current readings available of the sensed parameters 108. The Engineering Workstation (EWS) 250 is typically located at a remote station. Off-site locations, including the Engineering Workstation (EWS) 250, communicate with the programmable computer control subsystem 106 by any of a number of communication methods including, but not limited to, radio RF, modem, satellite, telephone lines, Ethernet/Internet, fiber optics, and the like as shown in FIG. 8. The antenna 252 which facilitates this communication is shown in FIGS. 1 and 2 connected directly to the Computer Operator Workstation (OWS) 246 via a line 270.

Reference to FIG. 2 clearly shows that the Computer Operator Workstation (OWS) 246 and the micro-Field Control Unit (FCU) 244 cooperate in the operation of the programmable computer control subsystem 106. The operator of the Construction De-Watering High Volume, Multi-Separation System 100 utilizes the Computer Operator Workstation (OWS) 246 to monitor and control the process, using the project configuration as established by the Engineering Workstation (EWS) 250. Displays at the Computer Operator Workstation (OWS) 246 include command windows, group displays, and project screens created during project configuration. These displays are populated with the real-time control status of device tags received from the Field Control Unit(s) (FCU) 244. Authorized operators can monitor detailed activity for many types of devices and send commands from displays appearing on the Operator Workstation Touch Screen Control 248. The Computer Operator Workstation (OWS) 246 also allows operators to display/acknowledge current alarms or display historical alarms. Logs and trends can be accessed by menu selection. Authorized operators can change security status or monitor device logic as it is running in the Field Control Unit (FCU) 244. Device diagnostics show the current status for each device tag. Device tags can be toggled on-scan and off-scan, and current values, i.e., sensed parameters 108, can be overridden. The operator interface, e.g., Operator Workstation Touch Screen Control 248, features high-resolution colorgraphics and familiar Windows Graphic User Interface (GUI) interaction. The Windows environment supports display of multiple project screens and windows. Data can be shared with other standard Windows applications.

The Field Control Unit (FCU) 244 executes the control scheme configured on the Engineering Workstation (EWS) 250 and directly scans industry Input/Output (I/O) as provided by the Digital/Analog, Input/Output Modules 242. The Field Control Unit (FCU) 244 provides Input/Output (I/O) services by monitoring and controlling Input/Output (I/O) across standard networks and data highways, such as, for example from the Digital/Analog, Input/Output Modules 242. The Field Control Unit (FCU) 244 can provide simultaneous support for multiple vendors' Input/Output (I/O) and Input/Output (I/O) networks. Field Control Unit (FCU) 244 connections are via standard, plug-in personal computer (PC) cards. This allows incorporation of distributed, distinct Input/Output (I/O) subsystems into common control strategies. Logic processing is performed by the Field Control Unit (FCU) 244 according to the schemes developed on the Engineering Workstation (EWS) 250 during project configuration. The logic for a particular device is solved within one Field Control Unit (FCU) 244 or a redundant pair of Field Control Units (FCU) 244. When a device is inserted into a device diagram during project configuration, it is associated with one Field Control Unit (FCU) 244. In effect, each device is “owned” by a particular Field Control Unit (FCU) 244. That Field Control Unit (FCU) 244 solves the logic for that device, then sends data updates to Computer Operator Workstations (OWS) 246 using exception-based reporting. Device data is shared with other Field Control Units (FCU) 244 if the control scheme requires it.

The flow of data is from the project configuration of the Construction De-Watering High Volume, Multi-Separation System 100 developed at the Engineering Workstation (EWS) 250 to the Field Control Unit (FCU) 244 and the Computer Operator Workstation (OWS) 246. The project is downloaded to the Field Control Unit (FCU) 244 and then to the Computer Operator Workstation (OWS) 246. The Field Control Unit (FCU) 244 solves the logic internally and sends the data, e.g., correction signals 110, to the Digital/Analog, Input/Output Modules 242 or (I/O) network. Alarms are also part of the device definition and are solved in the Field Control Unit (FCU) 244 and reported to the Computer Operator Workstation (OWS) 246. The Field Control Unit (FCU) 244 supports all the real-time functionality required of an industrial controller, including, but not limited to: (1) data acquisition; (2) regulatory control; (3) discrete control; (4) sequencing; (5) event-initiated processing; (6) interlocking; and (7) data calculation. The Field Control Unit (FCU) 244 features direct Ethernet network connections and standard interfaces to many specialized intelligent subsystems.

The following information is offered regarding exemplary specifications of the User Controllable Open System (UCOS) micro-Field Control Unit (FCU) 244 shown in FIGS. 2 and 7, the use of which is anticipated in the design and configuration of the programmable computer control subsystem (PCCS) 106. It is anticipated that the processor can comprise a Cirrus CS89712 having the following characteristics: 75 MHz ARM720 CPU core with MMU; 10 Mbps Ethernet; UART; SDRAM controller; Jumper-selectable boot ROM for “fail-safe” boot to download flash; and a JTAG debug port. The memory will be a 16 MB RAM; 8 MB flash memory; and 512 KB battery-backed SRAM. The clock will be a battery-backed realtime clock. The network interface will be an IEEE 802.3 network; 10Base-T with an RJ-45 connector; The serial port will be an RS-232 with RTS/CTS; using an RJ-45 connector with standard Digi/Connect Tech pinout. The power requirements {not including the Input/Output (I/O) power requirements} are 5.0 VDC (+ or −) 0.1 VDC with typical current loads of {a} 120 mAmps idle; {b} 200 mAmps during flood ping; and {c} 240 mAmps at power-up. The environmental characteristics include (1) an operating temperature range of between (0 degrees-to-60 degrees) Centigrade; (2) a storage temperature range of between (−40 degrees-to-85 degrees) Centigrade; and (3) a non-condensing, humidity range of between (0%-95%).

The following comments will now be offered to further explain the interaction of the Field Control Unit (FCU) 244 and the Computer Operator Workstation (OWS) 246. The micro-Field Control Unit (FCU) 244 is a computer processor unit, the specifications which have been set out above. The function of the Field Control Unit (FCU) 244 is {1} to provide control logic execution as configured by the Engineering Workstation (EWS) 250 and {2} to provide direct scanning of Input/Output (I/O) data where the (I/O) data is the sensed parameters 108 and/or the correction signals 110 being transmitted to or from the Digital/Analog, Input/Output Modules 242 as shown in FIG. 2. The Field Control Unit (FCU) 244 serves as an interface that allows the sensed parameters 108 that have been sensed by the banks of parameter sensors 142, 211, and 231 to read and feed into the computer located in the programmable computer control subsystem (PCCS) 106 within the NEMA enclosure 240. The computer located within the Computer Operator Workstation (OWS) 246 will utilize the sensed parameters 108 to (a) generate reports, and/or (b) adjust parameters such as, for example, alter the concentration of flocculant in the flocculation tank 144, or the concentration of acidic-to-basic levels for adjusting the pH level in the pH adjustment chemical tank 146 shown on FIG. 3A. The micro-Field Control Unit (FCU) 244 is installed into a computer at the Computer Operator Workstation (OWS) 246 where the computer can be (1) built into the NEMA enclosure 240, or (2) installed in a laptop computer carried by the systems engineer or the operator.

Furthermore, the Field Control Unit (FCU) 244 is the main processing point of the programmable computer control subsystem (PCCS) 106, that is, it is the location of (1) all input and output communications to and from the programmable computer control subsystem (PCCS) 106 of the measured sensed parameters 108, and also (2) it controls the components of the Construction De-Watering High Volume, Multi-Separation System 100. It is noted that all signals (e.g., sensed parameters 108 and correction signals 110) pass through the Field Control Unit (FCU) 244 shown in FIG. 2. The Computer Operator Workstation 246 is utilized as an operator interface with the programmable computer control subsystem (PCCS) 106. It is noted that it is not possible to program or set parameters of the programmable computer control subsystem (PCCS) 106 from the Computer Operator Workstation (OWS) 246. In particular, the Computer Operator Workstation (OWS) 246 (1) enables the operator to provide input signals, e.g., sensed parameters 108, and control signals to the programmable computer control subsystem (PCCS) 106, and (2) to monitor and control the process of the Construction De-Watering High Volume, Multi-Separation System 100 using the project configuration as set by the Engineering Workstation (EWS) 250 as presently defined. It is noted that the Field Control Unit (FCU) 244 and the Computer Operator Workstation (OWS) 246 are physically connected by a pair of data transmission lines. A line 272 transmits data from the Field Control Unit (FCU) 244 to the Computer Operator Workstation (OWS) 246 while a separate line 274 returns processed data, including correction signals 110, from the Computer Operator Workstation (OWS) 246 back to the Field Control Unit (FCU) 244.

The receipt of the sensed parameters 108 from the mechanical subsystem 104 and the return of the correction signals 110 from the programmable computer control subsystem (PCCS) 106 will now be explained in more detail. The sensed parameters 108 are transmitted from the various system components of the mechanical subsystem 104 shown in FIGS. 3A-3B to the Digital/Analog, Input/Output Modules 242 of the programmable computer control subsystem (PCCS) 106 via the communications lines 140. The sensed parameters 108 are measured signals directed to sensors that measure signals in real time such as, for example, temperature, pH level, resistivity, conductivity, turbidity, flow rate/totalizer, resistivity, and residual chemical concentrations. Some of these measured sensed parameters 108 are digital and some are analog in nature that are fed to the Digital/Analog, Input/Output Modules 242. An exemplary illustration of a suitable hardware combination of the Digital/Analog, Input/Output Modules 242 and the Field Control Unit (FCU) 244 exists in the User Controllable Open System (UCOS) processor shown in FIG. 7. This processor illustrates the Field Control Unit (FCU) 244 mounted on the same chassis as the Digital/Analog, Input/Output Modules 242. The Digital/Analog, input/Output Modules include {a} the plurality of digital input modules 256, {b} the plurality of digital output modules 258, {c} the plurality of analog input modules 260, and {d} the plurality of analog output modules 262 earlier described. The function of the Digital/Analog, Input/Output Modules 242 (also referred to as the Input/Output Board Rack) shown in FIGS. 2 and 7 is to receive all of the sensed parameters 108 (which are digital and analog signals) in real time. All of the digital and analog sensed parameters 108 are then routed to the Field Control Unit (FCU) 244 which is the local micro-Field Control Unit processor unit.

The Field Control Unit (FCU) 244 receives all of the digital and analog sensed parameters (signals) 108 from the Digital/Analog, Input/Output Modules 242 on the line 264 shown in FIG. 2. The Field Control Unit (FCU) 244 continuously monitors the plurality of sensed parameters 108 and is utilized for control logic execution and direct scanning of the sensed parameters 108 (e.g., input/output data of the mechanical subsystem 104) from the Digital/Analog, Input/Output Modules 242 into the computer located at the Computer Operator Workstation (OWS) 246. The Computer Operator Workstation (OWS) 246 is utilized as an operator interface with the programmable computer control subsystem (PCCS) 106. After receipt, the Field Control Unit (FCU) 244 then proceeds to identify the origin of each signal to determine where each sensed parameter (signal) 108 should be transmitted to in the Computer Operator Workstation (OWS) 246 via line 272. All of the data, e.g., sensed parameters 108, that is transmitted to the Computer Operator Workstation (OWS) 246 is continuously interpreted therein. It is noted that a storage memory 276 is located within the Computer Operator Workstation (OWS) 246 as shown in FIG. 2. One of the functions of the storage memory 276 is to store pre-programmed input data 278 therein to assist in controlling the operation of Programmable Fluid Treatment System 100.

The pre-programmed input data 278 is the pre-programmed data stored in the storage memory 276 of the Computer Operator Workstation (OWS) 246 utilized to compare the Input/Output sensed parameters 108 thereto. It is significant to note that the result of the comparison between (1) the sensed parameters 108 transmitted from the various components of the mechanical subsystem 104, and (2) the pre-programmed input data 278 stored in the storage memory 276 of the Computer Operator Workstation (OWS) 246 results in the signal differential or correction signals 110 that are transmitted back to the mechanical subsystem 104 to modify or correct the operation of the Construction De-Watering High Volume, Multi-Separation System 100. Consequently, the Computer Operator Workstation (OWS) 246 continuously interprets and compares the sensed parameters 108 with the pre-programmed input data 278 stored within the storage memory 276 for generating the plurality of correction signals 110. These correction signals 110 are then transmitted back to the Field Control Unit (FCU) 244 on line 274. The Field Control Unit (FCU) 244 then interprets and subsequently transmits the correction signals 110 to the proper modules (e.g., Digital Input Modules 256, Digital Output Modules 258, Analog Input Modules 260, or Analog Output Modules 262) in the Digital/Analog, Input/Output Modules 242 on line 266. Thereafter, the correction signals are transmitted from the Digital/Analog, Input/Output Modules 242 back to the proper component in the mechanical subsystem 104.

The Field Control Unit (FCU) 244 interprets where the correction signals 110 are returned to in the Digital/Analog, Input/Output Modules 242 after the computer of the Computer Operator Workstation (OWS) 246 reads the sensed parameters 108, makes the adjustments and control changes, and generates the correction signals 110, as necessary, to control the operation of the Construction De-Watering High Volume, Multi-Separation System 100. The Digital/Analog, Input/Output Modules 242 then sends the corrected, modified and adjusted control changes back to the corresponding parameter locations within the mechanical subsystem 104. This routing forms the “control feedback loop” that transmits the adjusted signals, such that, the Construction De-Watering High Volume, Multi-Separation System 100 makes modifications to the components of the mechanical subsystem 104. Examples of possible modifications to the components of the mechanical subsystem 104 include, but are not limited to: changes in pump speed of any of the main pumps 130, 136, 216, or 219; volume of flocculant injection into the multi-separation unit 150; pH level; or the flow or rate of flow of the fluid medium 102. The computer associated with the Computer Operator Workstation (OWS) 246 continues to constantly interpret the revised modified data, e.g., sensed parameters 108, from the mechanical subsystem 104. This continued monitoring ensures that the adjustments called for by the correction signals 110 are completed properly. In other words, the computer associated with the Computer Operator Workstation (OWS) 246 orders the adjustment or change and the continued monitoring verifies that the changes are actually completed.

These correction signals 110 facilitate adjustment and control modifications to the mechanical subsystem 104 for maintaining the sensed parameters 108 of the fluid medium 102 within the specified limitations set by the Regional Water Quality Control Board. Because of the continuous monitoring of the sensed parameters 108 by the Field Control Unit (FCU) 244 and the continuous interpreting and comparing of the sensed parameters 108 with the pre-programmed input data 278, the required adjustments and control modifications to the components of the mechanical subsystem 104 shown in FIGS. 3A-3B can be verified as having actually been completed. In other words, the computer associated with the Computer Operator Workstation (OWS) 246 reads the data (e.g., sensed parameters 108), initiates adjustment and control modifications, and then implements these adjustment and control changes as necessary to control the Construction De-Watering High Volume, Multi-Separation System 100. In this manner, each of the regulations that must be met prior to the discharge of the fluid medium 102 into local streams, lakes, and rivers are satisfied.

The Operator Workstation Touch Screen Control (Panel) 248 located within the NEMA enclosure 240 is shown in FIG. 2 as being in signal communication with the Computer Operator Workstation (OWS) 246. This connection enables any changes that can be made by the operator at the Computer Operator Workstation (OWS) 246 such as, for example, change in pump speed, to also be made from the Touch Screen Control Panel 248 (and also from the computer located at the Engineering Workstation 250). The signals that pass from the Computer Operator Workstation (OWS) 246 to the Touch Screen Control Panel 248 pass on a line 280. Likewise, the signals that pass from the Touch Screen Control Panel 248 back to the Computer Operator Workstation (OWS) 246 pass on a line 282. The information generated by the computer at the Computer Operator Workstation (OWS) 246 is displayed on the Touch Screen Control Panel 248 over line 280. Conversely, the Touch Screen Control Panel 248 is a transmitter/controller that creates input signals to control, for example, pump speed, are transmitted back to the Computer Operator Workstation (OWS) 246 over line 282. This “reverse connection” from the Touch Screen Control Panel 248 back to the Computer Operator Workstation (OWS) 246 routes the correction signals 110 back to the mechanical subsystem 104 via the Field Control Unit (FCU) 244 and the Digital/Analog, Input/Output Modules 242 as shown in FIG. 2.

As a result, the present invention facilitates the continuous adjusting and correcting of the sensed parameters 108 and reporting on-line and in real time to the regulatory authority. This continuous reporting includes the current operation of the mechanical subsystem 104 including the mix of the engineered chemicals 150 and the condition of the fluid medium 102. This important feature is extremely significant in that the concentration of the targeted compounds 114 during a fluid medium 102 (e.g., ground water) event at a construction site can be dynamic, that is, constantly changing. Thus, the operation of the Construction De-Watering High Volume, Multi-Separation System 100 can be modified to address this dynamic situation. Under these conditions, the sensed parameters 108 of temperature, pH level, resistivity, and conductivity can be constantly monitored as well as flocculant chemical metering levels, pump speeds, fluid medium flow rates, residual chemical concentrations, and the like. Thus, the rigid standards set by the Regional Water Quality Control Board can be satisfied prior to the discharge of the processed fluid medium 102 into the local streams, lakes, and rivers.

The programmable computer control subsystem 106 shows a block exhibiting the Off-Site Access Terminal 254 in FIG. 2. The Off-Site Access Terminal 254 can be any off-site location external to the Construction De-Watering High Volume, Multi-Separation System 100 that is utilized to communicate with the Computer Operator Workstation (OWS) 246 for obtaining data available from the most current readings available of the sensed parameters 108. The off-site location can be an office computer, even a computer that is located at a local government agency that sets rules and policy. That specific off-site location can seek access to the most recent sensed parameters 108 and receive the data from the Computer Operator Workstation (OWS) 246 on a line 286. Modifications to the operation of the components of the mechanical subsystem 104, such as pump speed or the concentration of the flocculent added to the multi-separation unit 150, can be inputted to the programmable computer control subsystem (PCCS) 106 from the Computer Operator Workstation (OWS) 246 via Off-Site Access Terminal 254 on a line 288 shown in FIG. 2. The modifications inputted from Off Site Access Terminal 254 to the programmable computer control subsystem (PCCS) 106 are processed at (1) the Computer Operator Workstation (OWS) 246 to generate correction signals 110, (2) identified by the Field Control Unit (FCU) 244, (3) transmitted to the Digital/Analog, Input/Output Modules 242 on line 266, (4) for eventual return to the corresponding component in the mechanical subsystem 104. Additional modifications can be inputted at the Off Site Access Terminal 254 that affect any sensed parameter 108 including the flow and flow rate, output levels at the effluent discharge diffuser 235, fluid levels of various system tanks, contact time of the fluid medium 102 with the flocculant, in addition to temperature, pH levels, resistivity, conductivity, flow rates/totalizer, and residual chemical concentrations.

The antenna 252 mounted on the NEMA enclosure 240 shown in FIG. 2 provides the programmable computer control subsystem (PCCS) 106 with the capability of communicating with other communication devices over all mediums over a system communications antenna link 290 as shown in FIG. 8. This communication capability is important because (a) the programmable computer control subsystem (PCCS) 106 can be remotely accessed from Off Site Access Terminal 254 shown in FIG. 2 to verify operations, and (b) the programmable computer control subsystem (PCCS) 106 is verified as controlling the Construction De-Watering High Volume, Multi-Separation System 100 to meet the discharge specifications as required by the Regional Water Quality Control Board and/or other governing agencies. Several of the communication devices over a plurality of mediums are illustrated in FIG. 8. Some of these communication devices include, but are not limited to: (1) a microwave link 292; (2) a satellite link 294; (3) a radio RF link 296; (4) a cell phone 298; (5) a telephone 300; (6) a Ethernet/Internet link via a desk top or lap top computer 302; (7) a smart phone 304; (8) an Ultra-High Frequency/Very High Frequency (UHF/VHF) device 306; (9) the programmable computer control subsystem (PCCS) 106 shown in FIG. 2; and (10) a modem/server 308, each illustrated in FIG. 8. Other possible links not shown include a fiber optic link. Many of these links carry low voltage, small signals over telephone lines. It is noted that the antenna 252 shown mounted on the NEMA enclosure 240 is shown directly connected to the Computer Operator Workstation (OWS) 246 via line 270 in FIG. 2. It is further noted that the present invention envisions other communication devices and links for cooperation with the programmable computer control subsystem (PCCS) 106, those communication devices and links not yet developed and available to the public at large.

Through the remote access feature of the Off Site Access Terminal 254 of the programmable computer control subsystem (PCCS) 106 shown in FIG. 2, via the multiple methods of communication set out immediately above and shown in FIG. 8, the operation of the Construction De-Watering High Volume, Multi-Separation System 100 can be modified to change parameters to meet the conditions of real time operations. These conditions, of course, are required to satisfy the fluid discharge requirements set by the local Regional Water Quality Control Board or other authoritative regulatory agency.

In distinction to the Off Site Access Terminal 254, the NEMA enclosure 240 is located on-site of the Construction De-Watering High Volume, Multi-Separation System 100 and all control functions are located within the NEMA enclosure 240. The programmable computer control subsystem (PCCS) 106 is designed to interpret the sensed parameters 108 and control signals delivered thereto on the plurality of communication lines 140 from the probes and sensors distributed throughout the mechanical subsystem 104. Some of those sensed parameters 108 include, but are not limited to, temperature, pH level of the fluid medium 102, resistivity, conductivity, flow sensors signals, flow rates/totalizer, residual chemical concentrations, and the like. The programmable computer control subsystem (PCCS) 106 adjusts the flocculation/separation levels; the pH level of the fluid medium 102 to a neutral reading of (7-8) on a pH scale of (0-14) acidic-to-basic; system flow levels; and contact time between the fluid medium 102 and the injected flocculants; and system operation to achieve the discharge parameters set by the relevant government agency. The standard of the present invention is always (a) to maximize the quality of the fluid medium 102 discharged into the local streams, lakes, and rivers, and (b) to meet or exceed all federal, state and local requirements and regulations for system operation, data archiving, real time reporting, and discharge requirements.

In the event of a mechanical or electrical problem associated with the operation of the Construction De-Watering High Volume, Multi-Separation System 100 such as the failure of a pump or a sensor, the programmable computer control subsystem (PCCS) 106 will (a) place the operation of the Construction De-Watering High Volume, Multi-Separation System 100 in a “safe mode” which typically means a re-circulation mode or shutdown mode, and (b) the programmable computer control subsystem (PCCS) 106 will enter an alarm mode and activate suitable alarms. The reference to the shutdown mode refers to the de-activation of most major components except those necessary to the discharge of fouled flocculants and targeted compounds 114 harmful to the mechanical subsystem 104. If the sensed parameters 108 of the discharged fluid medium 102 are not consistent with the design specifications, then, for example, the second duplex transfer pump station 214 can be placed in a re-circulation mode so that impurities resident within the fluid medium 102 are not discharged into the local streams, lakes and rivers. Additionally, if a pump fails such as, for example, the first transfer pump 130 (shown in FIG. 3A), resulting in a major failure, the programmable computer control subsystem (PCCS) 106 has the capability of alarming and contacting the appropriate repair maintenance group to correct the failure. Simultaneously, the failed pump is cycled into a “safe mode” which typically means that the failed pump is de-energized.

We will now turn our attention to the operation of the Construction De-Watering High Volume, Multi-Separation System 100 by making reference to the operational flow diagram appearing on FIGS. 9A to 9C. An identification number will be assigned to each step in the process to assist the reader in following the operational flow diagram. In a preferred embodiment, we begin with a first step 320 identified as “START” on FIG. 9A which initiates the operation of the Construction De-Watering High Volume, Multi-Separation System 100. Upon the occurrence of the ground fluid medium 102 typically appearing below grade at a construction site, pumps are typically utilized to remove the fluid medium 102 in a step 322 and to deliver the fluid medium 102 to the high volume inlet 120. An example is where pylons are being driven into the ground or into a waterway, such as a lake or a river, to provide structural support to a bridge or other structure. Next, the ground fluid medium 102 is delivered to the self-cleaning debris screen 122 in a step 324 where the large debris is removed by the debris transfer auger 124 and directed to a debris holding bin 126 in a step 326. The ground fluid medium 102 is then transferred to the first duplex transfer pump station 128 as shown in FIG. 3A in a step 328 where the fluid medium 102 is directed to either the first transfer pump 130 or the second transfer pump 136 through the associated control valves.

The fluid medium 102 is then pumped to the first bank of parameter sensors 142 shown in FIG. 3A where the various sensed parameters 108 are forwarded to the programmable computer control subsystem (PCCS) 106 for evaluation of the quality of the fluid medium 102 as shown in step 330 on FIG. 9A. As a result of the evaluation of the sensed parameters 108 by the programmable computer control subsystem (PCCS) 106, a measured level of engineered chemicals 167 (e.g., flocculants and pH chemicals) are injected into the stream of the fluid medium 102 in a step 332 by the first and second chemical metering pumps 148, 152, respectively. The fluid medium 102, which has now been chemically treated with the engineered chemicals 167, is directed to the first chamber 160 of the multi-separation unit 150 for mixing and aeration via the flocculant media mixers 169, and the blower/air pump 170 and fine air bubblier 171 as shown in a step 334. The treated fluid medium 102 then flows to the remaining chambers, e.g., second chamber 161, third chamber 162, and fourth chamber 163 of the multi-separation unit 150. The settlement and flotation of the sediment 112 and particulate matter (e.g., targeted compounds 114 and floating contamination 116) results in the settling of the sediment 112 and particulate matter to the bottom or floatation to the top of the multi-separation unit 150 as shown in step 336.

Thereafter, the sediment 112 of the mud-like sludge that settles on the bottom of the continuous loop conveyor 177, and the floatation of the floating contamination 116 on the top of the continuous loop conveyor 177 are removed by the rolling conveyor buckets 187 shown in FIGS. 4C-4E as is illustrated in step 338. Further, the speed of the continuous loop conveyor 177 and thus the forward movement of the rolling conveyor buckets 187 that carry away the sediment 112, targeted compounds 114, and the floating contamination 116, is a function of the settling rates of the sediment 112. This is interpreted as (a) the speed at which the sediment 112 and some targeted compounds 114 fall through the fluid medium 102, and (b) the rate at which the floating contamination 116 and agglomerated targeted compounds 114 rise to the top of the fluid medium 102 as shown in step 340 on FIG. 9B. The sludge (e.g., sediment 112 and some targeted compounds 114) is removed from the bottom of the multi-separation unit 150, and the top floating matter (e.g., floating contamination 116 and agglomerated targeted compounds 114) is removed from the top of the multi-separation unit 150. Once this occurs, both the sludge (e.g., sediment 112 and some targeted compounds 114) and the floating matter (e.g., floating contamination 116 and agglomerated targeted compounds 114) are directed to an on-site filter press 174 as is indicated by step 342.

The on-site filter press 174 receives both (a) the floating contamination 116 and agglomerated targeted compounds 114 from the plurality of float drains 173, and (b) the sludge (e.g., sediment 112 and some targeted compounds 114) from the discharge chute 202. The filter press 174 then processes both inputs and produces processed fluid medium 102 and soil cake 209 as recited in step 344. The processed fluid medium 102 is then returned to the influent inlet, e.g., the injection header 168, of the multi-separation unit 150 from the filter press 174 on line 208 for re-processing as shown in step 346 in FIG. 9B. Additionally, the soil cake 209 is further utilized to fill construction excavation sites as shown in step 348. Although the soil cake 209 includes certain of the engineered chemicals 167, it has been determined that the flocculants included in the engineered chemicals 167 are inert and thus not harmful to the environment. Next, the processed fluid medium 102 from the outflow chamber box 178 of the multi-separation unit 150 shown in FIG. 3B is directed to the second bank of parameter sensors 211 for measuring the sensed parameters 108 including but not limited to temperature, pH level, conductivity, turbidity, flow rate/totalizer, resistivity, and residual chemical concentrations as shown in step 350. The second bank of parameter sensors 211 forward the sensed parameters 108 to the programmable computer control subsystem (PCCS) 106 for evaluating the quality of the fluid medium 102 for the second time as shown in step 352.

At the output of step 352 which evaluates the quality of the processed fluid medium 102 based on the sensed parameters 108 of the second bank of parameter sensors 211, the issue becomes whether the quality of the processed fluid medium 102 satisfies the requirements of the Regional Water Quality Control Board as set forth in step 354. If the quality of the processed fluid medium 102 does not meet the standards of the Regional Water Quality Control Board (e.g., answer is “No”), then the programmable computer control subsystem (PCCS) 106 instructs the motor operated valve 213 to pass the fluid medium 102 to the Programmable Fluid Treatment System And Method 212 shown on FIG. 3B for further processing as is shown in step 356. Thereafter, the further processed fluid medium 102 is directed from the Programmable Fluid Treatment System And Method 212 to the second duplex transfer pump station 214 as shown in step 358 where either the first transfer pump 216 or the second transfer pump 219 will advance the fluid medium 102 forward. If the quality of the processed fluid medium 102 does meet the standards of the Regional Water Quality Control Board (e.g., answer is “Yes”), then the programmable computer control subsystem (PCCS) 106 instructs the motor operated valve 213 to pass the fluid medium 102 through the bypass line 215 so that the fluid medium 102 is sent directly to the second duplex transfer pump station 214 also shown in step 358 where either the first transfer pump 216 or the second transfer pump 219 will advance the fluid medium 102 forward. It is noted that the programmable computer control subsystem (PCCS) 106 controls each of the components of the mechanical subsystem 104 that is connected thereto via one of the communication lines 140. Thus, the quality of the fluid medium 102 at any point in the process as determined by the programmable computer control subsystem (PCCS) 106 controls the position of the components in the mechanical subsystem 104.

The processed fluid medium 102 is then pumped through the duplex security sock filter bank 222 as shown in FIG. 3A where either the first sock filter 224 or the second sock filter 227 via the associated isolation control valves 225, 226, or 228, 229, delete fine particulate matter in the fluid medium 102 as shown in step 360. Thereafter, the processed fluid medium 102 is pumped to the third bank of parameter sensors 231 for the final quality inspection by the programmable computer control subsystem (PCCS) 106 of the fluid medium 102 to be discharged from the construction de-watering high volume, multi-separation system 100 as shown in step 362. After the final quality inspection by the programmable computer control subsystem (PCCS) 106 of the fluid medium 102 to be discharged, the issue again becomes whether the quality of the processed fluid medium 102 satisfies the requirements of the Regional Water Quality Control Board prior to discharge as set forth in step 364.

If the quality of the processed fluid medium 102 does not meet the discharge standards of the Regional Water Quality Control Board (e.g., answer is “No”), then the programmable computer control subsystem (PCCS) 106 instructs the motor operated valve 233 to direct the fluid medium 102 back to the injection header 168 of the multi-separation unit 150 at step 334 for re-processing per step 366 shown on FIG. 9C. If the quality of the processed fluid medium 102 does meet the discharge standards of the Regional Water Quality Control Board (e.g., answer is “Yes”), then the programmable computer control subsystem (PCCS) 106 instructs the motor operated discharge valve 234 to pass the fluid medium 102 through the effluent discharge diffuser 235 and the associated perforations 236 as shown in step 368 on FIG. 9C. The fluid medium 102 is then discharged to local streams, lakes or rivers. The process is then complete, that is at an “END” as is indicated in step 370 shown on FIG. 9C. The system is now reset for a new cycle of processing fluid medium 102 pumped out of a construction site.

Thus, the preferred embodiment of the present invention is directed to a construction de-watering high volume, multi-separation system 100 for use in removing a fluid medium 102 from a construction site and having a mechanical subsystem 104 and a programmable computer control subsystem (PCCS) 106 wherein the mechanical subsystem 104 includes a high volume inlet 120 for injecting the fluid medium 102, chemical metering pumps 148, 152, for injecting engineered chemicals 167 into the fluid medium 102 for separating a plurality of targeted compounds 114 and controlling the pH level of the fluid medium 102, a multi-separation unit 150 including a continuous loop conveyor 177 for capturing sediment 112 deposited on the bottom of and contamination floating on the top of the fluid medium 102, the programmable computer control subsystem (PCCS) 106 arranged for continuously monitoring and comparing a plurality of sensed parameters 108 from the mechanical subsystem 104 with pre-programmed input data 278, and for generating correction signals 110 fed back to the mechanical subsystem 104 for maintaining the sensed parameters 108 within limitations, and for continuously adjusting and reporting in real time to a regulatory authority the operation of the mechanical subsystem 104.

The present invention provides novel advantages over other fluid treatment systems including storm water treatment systems that utilize conventional media filtration known in the prior art. A main advantage of the Construction De-Watering High Volume, Multi-Separation System And Method 100 (i.e., System 100) for use in removing a fluid medium 102 from a construction site is that: (1) the present invention is an “active treatment system” verses a media filtration system of the prior art; (2) resulting in the components of the System 100 cannot be fouled in the absence of conventional media filtration; and (3) consequently, the System 100 does not have back flush problems associated with clogged media filtration; (4) the System 100 incorporates a fully automated programmable computer control subsystem (PCCS) 106 that includes data logging and transmission of the current status to the system operator/end user and Regional Water Quality Control Board or other authority; (5) where the System 100 is constantly reading sensed parameters 108 from components of the mechanical subsystem 104 and comparing the sensed parameters 108 with pre-programmed input data 278 stored in the storage memory 276 shown in FIG. 2; (6) for continuously monitoring the sensed parameters 108 and generating correction signals 110; (7) where the correction signals 110 are utilized to modify the operation of the mechanical subsystem 104 for maintaining the quality of the processed fluid medium 102 within the standards required by the Regional Water Quality Control Board; (8) where all major components of the mechanical subsystem 104 are continuously reporting sensed parameters 108 to the programmable computer control subsystem (PCCS) 106 for evaluation; (9) the System 100 including a System Communications Antenna Link 290 that can communication with a plurality of modern communication devices; and (10) the programmable computer control subsystem (PCCS) 106 can be accessed from the Engineering Workstation (EWS) 250, Computer Operator Workstation (OWS) 246, and the Off Site Access (Terminal) 254.

Another main advantage is that the Construction De-Watering High Volume, Multi-Separation System 100 of the present invention includes (11) a continuous bop conveyor 177 fabricated within the multi-separation unit 150 utilized for removing sludge (e.g., sediment 112, targeted compounds 114) from the bottom of the mufti-separation unit 150, and removing floating contamination 116 from the top of the multi-separation unit 150 for cleansing the fluid medium 102 prior to discharge to local streams, lakes and rivers. Further, (12) the present invention utilizing the “active treatment system”, meets and exceeds all federal, state and local fluid discharge requirements. Finally, (13) the present invention facilitates remote access to the recorded data in the storage memory 276 of the Computer Operator Workstation (OWS) 246 by the Regional Water Quality Control Board or other regulatory agency to verify operations and compliance. This access can be obtained by utilizing any of the communications devices shown in Applicant's FIG. 8. This remote access is an advance in the art in the fact that personnel of the regulatory agency do not have to visit the site to collect the recorded data to verify operations and compliance. The recorded data can be electronically downloaded from any convenient location.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility such as, for example, fluid processing facilities. It is therefore intended by the appended claims to cover any and all such modifications, applications and embodiments within the scope of the present invention. Accordingly,

1. A construction de-watering high volume, multi-separation system for use in removing a fluid medium from a construction site comprising:
a mechanical subsystem and a programmable computer control subsystem;
a high volume inlet for injecting and distributing a fluid medium into said mechanical subsystem;
means for injecting a mix of engineered chemicals into said fluid medium within a multi-separation unit for separating out a plurality of targeted compounds and for controlling the pH level of said fluid medium;
said multi-separation unit including a dual purpose continuous loop conveyor for capturing sediment deposited on the bottom of and contamination floating on the top of said fluid medium within said multi-separation unit; and
said programmable computer control subsystem arranged for continuously monitoring and for continuously comparing a plurality of sensed parameters from said mechanical subsystem with a plurality of pre-programmed input data, and for continuously generating a plurality of correction signals fed back to said mechanical subsystem for maintaining said sensed parameters of said fluid medium within limitations, and for continuously adjusting and reporting in real time to a regulatory authority the operation of said mechanical subsystem.

2. The construction de-watering high volume multi-separation system of claim 1 further including a self cleaning debris screen for filtering out large debris from said fluid medium.

3. The construction de-watering high volume multi-separation system of claim 1 further including a plurality of transfer pumps for moving said fluid medium throughout said mechanical subsystem.

4. The construction de-watering high volume multi-separation system of claim 1 wherein said means for injecting engineered chemicals into said fluid medium further includes a flocculation tank and a first chemical metering pump.

5. The construction de-watering high volume multi-separation system of claim 1 wherein said means for injecting engineered chemicals into said fluid medium further includes a pH adjustment chemical tank and a second chemical metering pump.

6. The construction de-watering high volume multi-separation system of claim 1 wherein said multi-separation unit is divided into four zones where adjacent zones are separated by a baffle having a plurality of penetrations formed therein.

7. The construction de-watering high volume multi-separation system of claim 1 further including a fine air bubblier for creating fine bubbles for mixing with said fluid medium, said targeted compounds, and said engineered chemicals for forming a floating agglomeration in said multi-separation unit.

8. The construction de-watering high volume multi-separation system of claim 1 further including a blower-air pump for forcible mixing and attaching a plurality of fine bubbles to said engineered chemicals and said targeted compounds in said fluid medium for forming a floating agglomeration in said multi-separation unit.

9. The construction de-watering high volume multi-separation system of claim 1 further including at least one electric mixer for mixing said engineered chemicals into said fluid medium within said multi-separation unit.

10. The construction de-watering high volume multi-separation system of claim 1 wherein said continuous loop conveyor of said multi-separation unit further includes a continuous trough through which a plurality of conveyor buckets are pulled by a conveyor drive unit.

11. The construction de-watering high volume multi-separation system of claim 1 further including a filter press for pressing said captured sediment and said floating contamination for repatriation of residual fluid medium and disposal of pressed sediment.

12. The construction de-watering high volume multi-separation system of claim 1 further including an effluent discharge diffuser having a plurality of perforations formed therein for increasing the discharge area for processed fluid medium.

13. The construction de-watering high volume multi-separation system of claim 1 further including multiple banks of parameter sensors for making real time measurements of a plurality of sensed parameters of said fluid medium.

14. The construction de-watering high volume multi-separation system of claim 13 wherein said sensed parameters are transmitted to said programmable computer control subsystem on a real time basis for controlling the operation of said mechanical subsystem.

15. A construction de-watering high volume, multi-separation system for use in removing a fluid medium from a construction site comprising:
a mechanical subsystem and a programmable computer control subsystem;
a high volume inlet for injecting and distributing a fluid medium into a debris filter stage of said mechanical subsystem;
means for injecting a mix of engineered chemicals into said fluid medium within a multi-separation unit for separating out a plurality of targeted compounds and for controlling the pH level of said fluid medium;
said multi-separation unit including a dual purpose continuous loop conveyor for capturing sediment deposited on the bottom of and contamination floating on the top of said fluid medium, said continuous loop conveyor further including a continuous trough through which a plurality of rolling conveyor buckets are pulled by a drive chain engaged by a conveyor drive unit; and
said programmable computer control subsystem arranged for continuously monitoring and for continuously comparing a plurality of sensed parameters from said mechanical subsystem with a plurality of pre-programmed input data, and for continuously generating a plurality of correction signals fed back to said mechanical subsystem for maintaining said sensed parameters of said fluid medium within limitations, and for continuously adjusting and reporting in real time to a regulatory authority the operation of said mechanical subsystem.

16. The construction de-watering high volume multi-separation system of claim 15 wherein said continuous trough formed in said continuous loop conveyor is fashioned from steel.

17. The construction de-watering high volume multi-separation system of claim 15 wherein said continuous trough includes a plurality of float drains for enabling said contamination floating on top of said fluid medium to escape to a filter press.

18. A construction de-watering high volume, multi-separation system for use in removing a fluid medium from a construction site comprising:
a mechanical subsystem and a programmable computer control subsystem;
a high volume inlet for injecting and distributing a fluid medium into said mechanical subsystem;
means for injecting a mix of engineered chemicals into said fluid medium within a multi-separation unit for separating out a plurality of targeted compounds and for controlling the pH level of said fluid medium;
said multi-separation unit including a dual purpose continuous loop conveyor for capturing sediment deposited on the bottom of and contamination floating on the top of said fluid medium, said continuous loop conveyor further including a continuous trough having a raceway channel through which a plurality of rolling conveyor buckets are pulled by a conveyor drive unit; and
said programmable computer control subsystem arranged for continuously monitoring and for continuously comparing a plurality of sensed parameters from said mechanical subsystem with a plurality of pre-programmed input data, and for continuously generating a plurality of correction signals fed back to said mechanical subsystem for maintaining said sensed parameters of said fluid medium within limitations, and for continuously adjusting and reporting in real time to a regulatory authority the operation of said mechanical subsystem.

19. The construction de-watering high volume multi-separation system of claim 18 wherein said raceway channel formed within said continuous trough is fashioned from steel.
